(19) United States
(12) Patent Application Publication
(10) Pub. No.: US 2007/0013624 A1
(43) Pub. Date: Jan. 18, 2007

(54) DISPLAY

(76) Inventor: Grant BOURHILL, Stow-on-the-Wold (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/456,107

(22) Filed: Jul. 7, 2006

(30) Foreign Application Priority Data
Jul. 13, 2005 (GB) 0514278.1

(51) Int. Cl. G09G 3/34

(52) U.S. Cl. 345/84

(57) ABSTRACT

A display is provided having a multiple view mode of operation and a wide angle single view mode. The display comprises a transmissive spatial light modulator which displays spatially multiplexed images in the multiple view mode and a single image with full resolution in the single view mode. The modulator has an input polariser which passes light of a first polarisation. A backlight has a light output surface with alternating first and second regions of parallel strip shape. The backlight is electronically switchable between the multiple view and single view modes. In the multiple view mode, only the first regions emit light containing the first polarisation. In the single view mode, both regions emit light containing the first polarisation.

This Nonprovisional application claims priority under 35 U.S.C. § 119(a) on Patent Application No. 0514278.1 filed in U.K. on Jul. 13, 2005, the entire contents of which are hereby incorporated by reference.

### FIELD OF THE INVENTION

The present invention relates to displays. For example, such displays may have at least one mode in which images of independently selectable content are visible only in respective different viewing regions. An example of an application of such a display is in the dashboard of a vehicle for viewing by a driver and, when present, one or more passengers.

### BACKGROUND OF THE INVENTION

Although such displays may be capable of displaying any number of views visible in a corresponding or different number of viewing regions, many applications require only two views. Displays of this type are referred to as dual view displays. FIG. 1 of the accompanying drawings illustrates the operation of such a dual view display in a vehicle dashboard. For example, the display may provide the driver with navigation information, such as that obtained from a GPS system, while permitting a passenger to view identical or different content. For example, the passenger may view images reproduced from a DVD player.

FIG. 2 of the accompanying drawings illustrates the operation of a known type of dual view display, for example as disclosed in GB 2405542. A parallax optic 1, for example in the form of a parallax barrier or a lenticular lens array, cooperates with a spatial light modulator (SLM) 2, such as a liquid crystal device (LCD), to define viewing regions 3. Two images of independently selectable content are displayed in a spatially interlaced or spatially multiplexed configuration by the SLM 2 and the parallax optic 1 controls visibility of the pixels such that only the pixels displaying a first of the images are visible in a first viewing region and only the pixels displaying the second image are visible in the second viewing region.

FIG. 3 of the accompanying drawings illustrates a structure of a known example of such a dual view display. The SLM 2 comprises an LCD having substrates 4 and 5, between which is disposed an LCD pixel plane 6. The outer surfaces of the substrates 4, 5 carry viewing angle enhancement films 7 and polarisers 8. In this example, the parallax optic is a parallax barrier 1 disposed between the LCD and a backlight 10. The barrier comprises a substrate 11 and an aperture array 12 and cooperates with the LCD 2 to form viewing windows 13 and 14 at the widest part of respective viewing regions 3 in a viewing window plane 15. The centres of the viewing windows 13 and 14 each subtend a half angle α at the aperture array 12 to a normal to the display.

If the half angle αbetween the viewing windows 13 and 14 is such that the centres of the viewing windows 13 and 14 are spaced apart nominally at the eye separation of a viewer, an autostereoscopic three dimensional (3D) display may be provided by spatially interlacing or multiplexing related 2D images which exhibit binocular disparity. Alternatively, if the half angle between the centres of the windows 13 and 14 is such that the window centres are spaced apart by substantially more than the typical viewer eye separation, it is possible to provide a dual view (or multiple view) display such that each user in each viewing region sees a 2D image and the image contents may be independently selectable.

In a spatially multiplexed display of this type, the number of picture elements which can be seen from any one viewing region is inversely proportional to the number of primary viewing zones created by the parallax barrier 1. When such a display is used as an autostereoscopic 3D display, this disadvantage is partially compensated because one viewer sees all of the pictures elements (pixels) of the LCD 2, with one eye seeing half of the pixels and the other eye seeing the remaining half of the pixels. However, for a dual or multiple view display, each viewer sees an image whose resolution is degraded compared to the basic spatial resolution of the LCD 2. This may create image degradation problems through colour artefacts and anti-aliasing issues. Further, for certain parallax barrier and SLM designs, the image may be further degraded due to the spatial frequency of the parallax barrier being substantially less than the maximum spatial frequency that can be resolved by the human eve. This is the so-called “prison bar” effect.

WO2004/088996 discloses a temporally switching display that creates one image for one viewer in one time frame and the potential for the same or a different image to a different viewer in a second time frame. The main embodiment of this prior art is shown in FIG. 4. In this type of temporal multiplexed system, each individual user can see a full resolution display image but with the images time interlaced with nominally black images. The effective image refresh rate is thus only 50% that of the conventional display. This cycle of image-black-image-black can create a very noticeable flicker effect and is particularly noticeable for liquid crystal displays at low temperatures, for example those observed in some automotive applications. The display device disclosed in this prior art can be used for either autostereoscopic display or dual-view display. However in the case of a dual-view display, scatter from the plastic waveguide and corresponding plastic structure can lead to very distracting image mixing. For dual-view this problem is more noticeable since typically two totally independent images will be displayed, which is not the case for autostereoscopic displays, especially those displaying images with small disparities.

A similar time multiplexing system, with similar drawbacks, is disclosed in WO 2004/27492.

PCT patent application WO 03/015424 discloses a system for electronically switching of a 2D and multi-view system. However the embodiments that are described require the display to operate in either NW (normally white) or NB (normally black) in one mode, and the opposite for the other mode. This leads to reduction in image quality in one of the modes. Further, this system relies on liquid crystal lenses and these are often relatively scattering. This scattering can lead to image mixing and, as described above, this image mixing can be very noticeable. Yet further, the embodiments disclosed describe a multi-view system where each viewer is positioned in a secondary rather than a primary view zone. This multi-view configuration degrades the users head freedom compared to a configuration providing nominally only 2 independent primary zones over the full view zone of the display. This reduction in head freedom is particularly problematic for an automotive environment where full head freedom for a driver or passenger is required. Finally, in an automotive environment, the images from the display have to be imaged at reasonably high angles and image degradation or image mixing may result from the lens aberrations related to such high angle imaging.

### SUMMARY OF THE INVENTION

According to a first aspect of the invention, there is provided a display having a first multiple view mode of operation and a second single view mode of operation, comprising: a transmissive spatial light modulator arranged, in the first mode, to display a plurality of spatially multiplexed images for viewing in respective different viewing regions and in the second mode, to display a single image for viewing in a single relatively large viewing region, the modulator having an input polariser arranged to pass light of a first polarisation; and a backlight having a light output surface comprising first regions spaced apart by second regions and being electronically switchable between the first mode, in which only the first regions emit light containing the first polarisation, and the second mode, in which both the first and second regions emit light containing the first polarisation.

The output surface may comprise a patterned retarder and the first and second regions may be arranged to provide a difference in retardation of λ/2, where λ is a wavelength of visible light. The backlight may comprise a light guide disposed behind the output surface, a first light source arranged to supply polarised light into the light guide, and a second light source arranged to supply unpolarised light into the light guide.

The first polarisation may be a linear polarisation and the backlight may comprise a light guide and first and second light sources arranged to supply into the light guide light of second and third linear polarisations which are orthogonal and which are oriented at + and −45°, respectively, to the first polarisation. The first regions may be index-matched to the light guide for only the second polarisation and the second regions may be indexed-matched to the light guide for only the third polarisation.

The output surface may comprise a liquid crystal device and the second regions may be switchable between a light-blocking mode and a light-transmitting mode for the first and second modes of operation, respectively.

According to a second aspect of the invention, there is provided a multiple view display comprising: a spatial light modulator comprising a plurality of pixels and being arranged to display N spatially multiplexed images simultaneously in each time frame of a cyclically repeating set of N time frames, where N is an integer greater than one, such that each pixel displays an image pixel of different ones of the images indifferent time frames of each set; and a parallax optic cooperating with the modulator to make each of the N images visible in the same respective one of the N viewing regions during all of the time frames.

A display of the second aspect can create the impression of 2-D resolution by time multiplexing but without introducing nominally full area black periods between frame refresh to each user (in other words, it uses time multiplexing of a spatially multiplexed display rather than full frame temporal multiplexing). A user can perceive the full 2D screen resolution without coarse image flickering problems associated with the conventional image-black-image-black cycle discussed previously in full frame temporal multiplexed schemes. Further the image quality is improved (there is a reduced “prison-bar” effect) compared to a fixed dual-view display with parallax barriers.

The parallax optic may comprise parallax elements (transmissive slits) whose positions are different in the N frames of each set. The parallax optic may comprise a parallax barrier.

N may be equal to 2.

The barrier may comprise a switching half wave plate and a patterned retarder. The patterned retarder may be a patterned half wave plate. The patterned half wave plate may comprise first and second regions having optic axes oriented at + and −22.5°, respectively, with respect to a reference direction and the switching half wave plate may have an output polarisation which is switchable between + and −45°, the barrier comprising a polariser having a transmission axis at 45°, the switching half wave plate and the patterned half wave plate being disposed between the polariser and a further polariser having a transmission axis at 90°.

The modulator may be a liquid crystal device.

The parallax optic may comprise first and second polarisation sensitive lens arrays offset laterally with respect to each other and sensitive to orthogonal linear polarisations, a switching half wave plate, and an output linear polariser.

A third aspect of the present invention provides a display having a first multiple view mode of operation and a second single view mode of operation, comprising: a transmissive spatial light modulator comprising a plurality of pixels and a backlight; the modulator being arranged, in the first mode, to display N spatially multiplexed images simultaneously in each time frame of a cyclically repeating set of N time frames, where N is an integer greater than one, such that each pixel displays an image pixel of different ones of the images in different time frames of each set, and being arranged to display, in the second mode, a single image for viewing in a single relatively large viewing region; and the backlight being switchable between the first mode in which it cooperates with the modulator to make each of the N images visible in the same respective one of the N viewing regions during all of the time frames, and the second mode.

A display of this aspect of the invention is operable either in a full-resolution 2D mode without time multiplexing or in a multiple view directional display mode in which full-resolution is achieved by time multiplexing. The image quality of the 2D mode is improved due to effectively eliminated reduction of flickering since no time multiplexing is used. Further the image quality of the multiple view directional display mode is improved owing to enhanced resolution and a reduced “prison-bar” effect.

The modulator may be arranged, in the second mode, to display the single image by all of the modulator pixel.

The backlight may comprise a plurality of parallel light output strips. Adjacent ones of the strips may be contiguous with each other. The strips may be arranged as groups of M strips below each column of pixels, where M is an integer greater than one. M may be equal to (N+1), all of the strips may emit light in the second mode and, in the first mode, each of N of the strips of each group may emit light during a respective one of the N time frames of each set.

The pitch of the strips may be substantially equal to an integer multiple of a column pitch of the pixels.

The output strips may be light-emitting strips.

The backlight may comprise a lightguide, a visible light source arranged to emit visible light into the light guide, and an ultraviolet light source arranged to emit ultraviolet light into the light guide, the light guide having first output regions which are transparent to visible light interlaced with second output regions comprising ultraviolet-activated luminescent material.

The modulator may have an input polariser arranged to pass light of a first polarisation; and the backlight may have a light output surface comprising first regions spaced apart by N second regions and being electronically switchable between the first mode, in which only the i^{th} second region emit light containing the first polarisation in each i^{th} time frame of each repeating cycle of N time frames, and the second mode, in which both the first and second regions emit light containing the first polarisation.

A fourth aspect of the present invention provides a display comprising: a transmissive spatial light modulator having at least a first region for modulating light of a first wavelength range and a second region for modulating light of a second wavelength range not overlapping the first wavelength range; and a backlight having at least a first region for outputting light within the first wavelength range and a second region for outputting light within the second wavelength range; wherein the spatial light modulator and the backlight are arranged such that light output from the first region of the backlight along a predetermined axis of the display is not incident on the first region of the spatial light modulator and such that light output from the second region of the backlight along a predetermined axis of the display is not incident on the second region of the spatial light modulator.

The predetermined axis may be, for example, the normal axis to the display face of the display. The arrangement of the spatial light modulator and the backlight sets up viewing regions on either side of the predetermined axis.

This aspect of the invention may be embodied using, for example, a liquid crystal SLM with a colour filter array. The regions of the backlight co-operate with the colour filters of the liquid crystal SLM to form a multiple view directional display. Light is emitted by the backlight only in the correct location for a multiple view directional display, and this increases luminance and decreases image mixing.

According to a fifth aspect of the invention, there is provided a multiple view display comprising:

a transmissive spatial light modulator comprising repeating groups of X columns of pixels, where X is an integer greater than one and each ith column of each group is arranged to modulate light in an ith wavelength range and substantially to block light in each jth wavelength range for all i and j such that 1≦i≦X, 1≦j≦X and i≠j; and

a backlight having repeating groups of X light output strips extending parallel to the pixel columns, where each ith strip is arranged to output light in the ith wavelength range and outside each jth wavelength range, the width of each ith strip being less than or equal to the width of the space between adjacent ith columns of adjacent column groups.

X may be equal to three. The wavelength ranges may comprise red, green and blue wavelength ranges.

Adjacent pairs of the strips may be substantially contiguous with each other.

The backlight may comprise a carbon nanotube backlight.

The ith columns of each adjacent pair may be laterally symmetrically disposed with respect to a corresponding ith strip.

Each column may comprise a single line of pixels.

According to a sixth aspect of the invention, there is provided a backlight having at least a first region for outputting light within a first wavelength range and a second region for outputting light within a second wavelength range not overlapping with the first wavelength range, the first region comprising an emissive material emitting, in use, light within the first wavelength range and the second region comprising an emissive material emitting, in use, light within the second wavelength range.

The backlight may comprise a carbon nanotube backlight.

The at least first and second regions may comprise a plurality of regions arranged as repeating groups.

### BRIEF DESCRIPTION OF THE DRAWINGS

The invention will be further described, by way of example, with reference to the accompanying drawings, in which:

FIG. 1 illustrates an application of a dual view display;

FIG. 2 is a diagram illustrating a known type of dual view display;

FIG. 3 is a diagrammatic cross-sectional view of a known type of dual view display;

FIG. 4 illustrates another known type of multiple view display of time-sequential type;

FIG. 5 is a diagram illustrating a multiple view display constituting an embodiment of the invention;

FIG. 6 is a diagram illustrating another multiple view display constituting an embodiment of the invention;

FIG. 7 is a diagram illustrating a further multiple view display constituting an embodiment of the invention;

FIG. 8 is a diagram illustrating another multiple view display constituting an embodiment of the invention;

FIGS. 9 and 10 are diagrams illustrating operation of the display of FIG. 8;

FIG. 11 illustrates the operation of a display constituting another embodiment of the invention;

FIG. 12 is a diagram illustrating another multiple view display constituting an embodiment of the invention;

FIGS. 13 and 14 are diagrams illustrating another multiple view display constituting an embodiment of the invention;

FIG. 15 is a diagram illustrating another multiple view display constituting an embodiment of the invention;

FIGS. 16a and 16b are diagrams illustrating another multiple view display constituting an embodiment of the invention;

FIG. 17 is a diagram illustrating another multiple view display constituting an embodiment of the invention;

FIG. 18 is a diagram illustrating another multiple view display constituting an embodiment of the invention;

FIG. 19 is a diagram illustrating another known display;

FIG. 20 is a diagram illustrating another multiple view display constituting an embodiment of the invention:

FIG. 21 is a diagram illustrating another multiple view display constituting an embodiment of the invention;

FIG. 22(a) to 22(c) illustrate operation of the display of FIG. 21;

FIG. 23 is a diagram illustrating another multiple view display constituting an embodiment of the invention; and

FIG. 24 is a diagram illustrating another multiple view display constituting an embodiment of the invention.

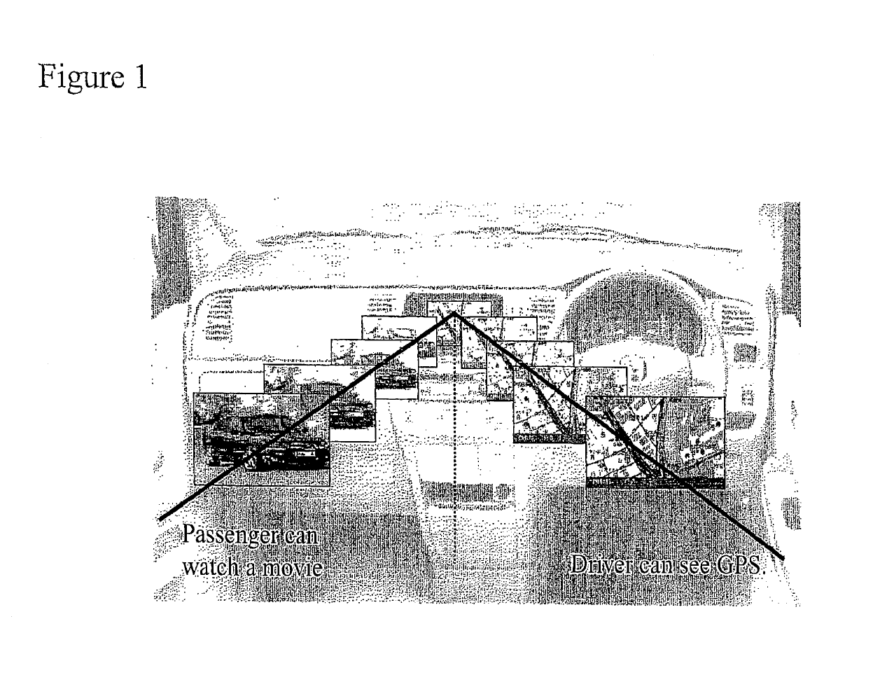

Like reference numerals refer to like parts throughout the drawings.

### DESCRIPTION OF THE EMBODIMENTS

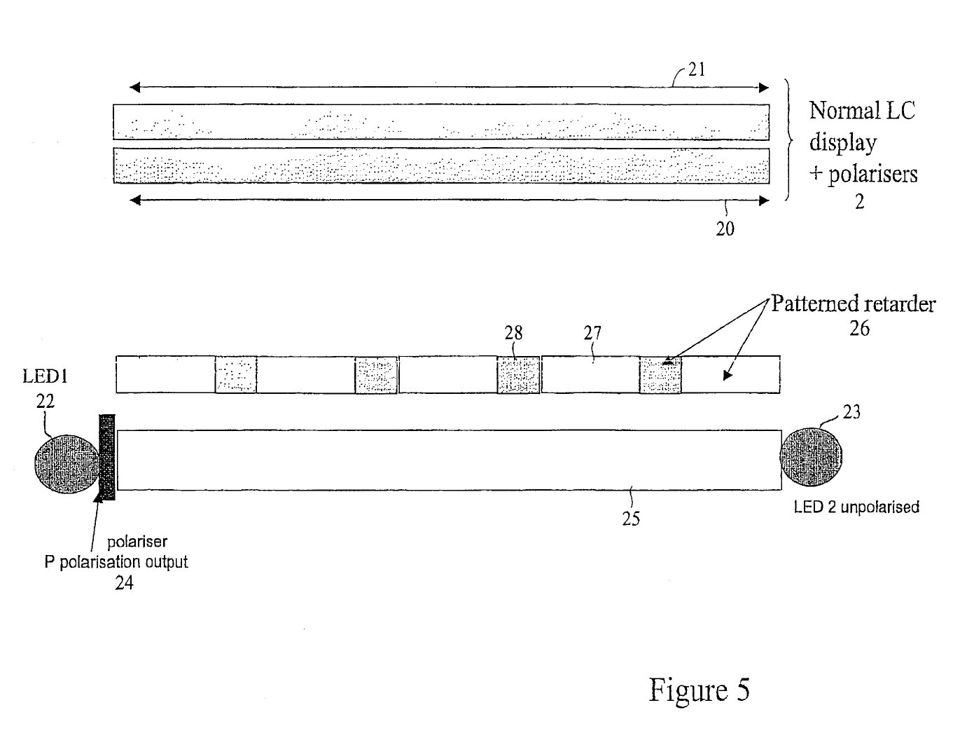

The display shown in FIG. 5 comprises a conventional LCD 2 including input and output polarisers 20 and 21. The LCD 2 is of the transmissive or trans-reflective type and cooperates with a backlight comprising light sources 22 and 23, for example comprising light emitting diodes (LEDs), a polariser 24 which, in this example, transmits P polarised light, a light guide 25, and a patterned retarder 26. In order to prevent or reduce depolarisation of the polarised light supplied by the light source 22 and the polariser 24 within the light guide 25, the light guide may contain nanoparticle elements for reducing residual birefringence as described in Proceedings of International Displays Workshop 2004, paper LCT4-3 “Nanoparticle Zero Birefringence Backlight Waveguide”.

The patterned retarder 26 comprises a half wave plate having regions such as 27, whose optic axis is oriented so as not to have an effect on P polarised light, and regions 28, whose optic axis is oriented so as to rotate P polarised light by 90°.

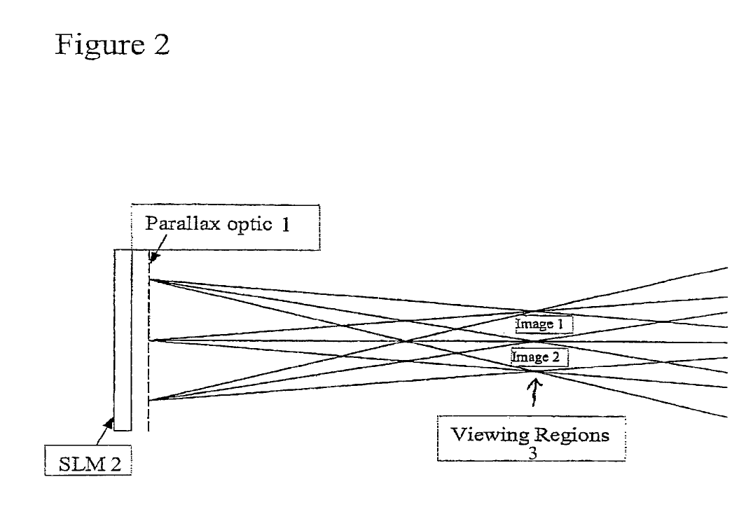

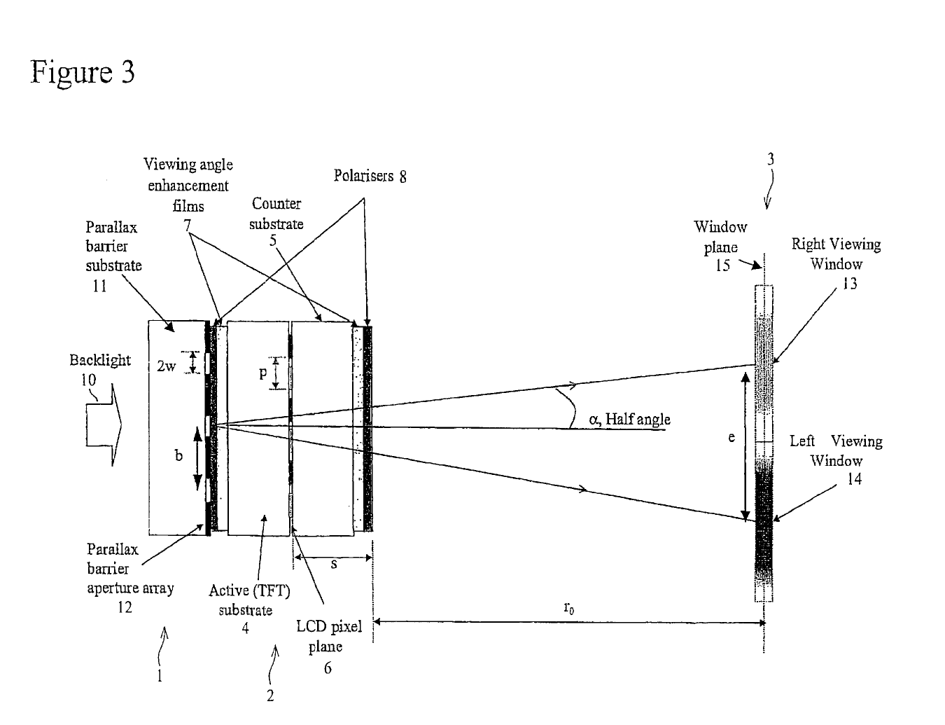

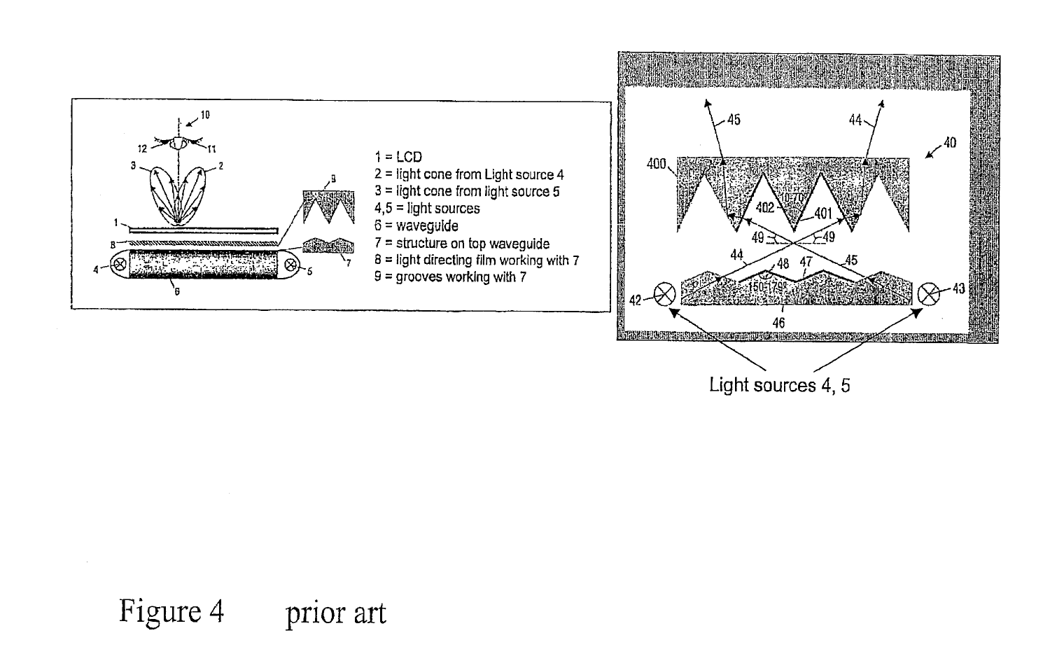

In the multiple or dual view mode of operation, the light source 22 is illuminated whereas the light source 23 is switched off. The P polarised light from the polariser 24 passes through the regions 27 of the retarder 26 without having its polarisation altered. The transmission axis of the input polariser 20 of the LCD 2 is oriented so as to block P polarised light. The regions 28 rotate the P polarised light by 90° so that light from the regions 28 is passed by the polariser 20. The regions 27 and 28 are arranged as vertical strips so that the backlight in conjunction with the input polariser 20 acts as a plurality of parallel light-emitting strips. The display therefore operates as a dual or multiple view display as illustrated in FIGS. 2 and 3.

In the single view wide viewing angle mode of operation, the light source 22 is switched off and the unpolarised light source is illuminated. Unpolarised light is transmitted via the light guide 25 and the retarder 26 and light from all of the regions 27 and 28 is passed by the polariser 20 so that the backlight acts as a substantially uniformly emitting backlight of Lambertian type. The LCD 2 displays a single 2D image with its full spatial resolution and this image can be viewed throughout a wide viewing region.

In a preferred embodiment, the patterned retarder element comprises a liquid crystal material with a spatially varying liquid crystal director alignment that has an orientation of 0° with respect to a reference direction, such as the vertical direction with the display in normal use oriented in a vertical plane, in regions 27 of the retarder and that has an orientation of 45° to the reference direction in regions 28 of the retarder. The retarder acts as a half-wave retarder. Such a patterned retarder is described in EP 0 829 744. The rear polariser 20 of the image forming display has its transmission direction at 90° to the reference direction. In the dual-view or multiple-view mode of operation, the light source 22 is illuminated and this outputs light which is nominally polarised at 0 to the reference direction by the polariser 24. The polarisation state of the light is converted by the patterned retarder 26 to a spatially varying polarisation state of 0° and 90°. The rear polariser 20 of the image forming display only allows one of these components to pass and so in this way an array of vertical apertures of finite horizontal extent is created.

FIG. 5 shows one backlight waveguide 25 provided for both light sources 22,23, but the invention is not limited to this configuration. For example, the backlight waveguide system may be comprised of two independent waveguides, of which the first co-operates only with one light source 22 and the second co-operates only with the second light source 23.

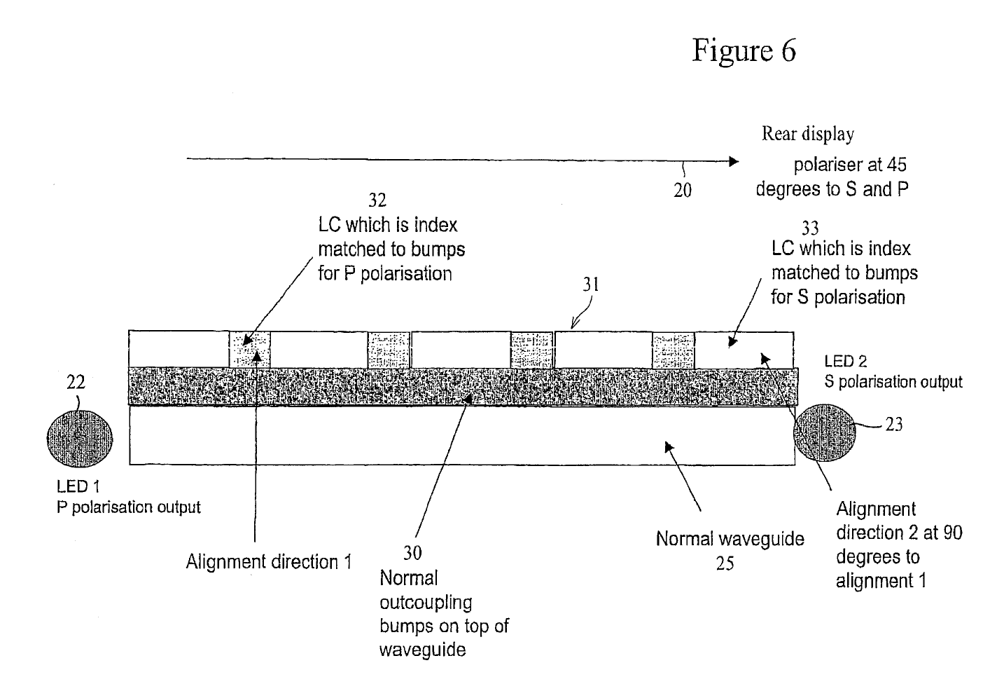

The multiple or dual view display shown in FIG. 6 differs from that shown in FIG. 5 in that the light source 23 emits S polarised light into the lightguide or waveguide 25. The lightguide 25 has an output coupling arrangement 30 coupling the lightguide 25 to a spatially varying refractive output surface 31. The input polariser 20 of the LCD (the rest of which is not shown in FIG. 6) has a transmission axis oriented at 45° to the S and P polarised light from the backlight.

The liquid crystal output surface 31 has regions 32 which are index-matched to the structure 30 and which have a first alignment direction. The output surface 31 also has regions such as 33 which are indexed-matched to the structure 30 and whose alignment direction is orthogonal to the alignment direction of the regions 32.

In the dual or multiple view mode of operation, the light source 23 is switched on whereas the light source 22 is switched off. The S polarised light from the light source 23 is not scattered by the regions 33 which are index-matched for S-polarised light and is guided within the waveguide. When the S-polarised light is incident on a region 32 which is not index-matched for S-polarised light it is scattered owing to the lack of index matching. Some S-polarised light is scattered by the regions 32 back into the light guide 25, and some is forward scattered out of the waveguide 25 towards the image forming display. In other words, when the S polarised light source 23 only is illuminated, light emission occurs only from the regions 32 which are not index-matched for S-polarised light, and no light emission occurs from the regions 33 which are index-matched for S-polarised light. The regions 32 and 33 are arranged as parallel vertically extending strips so that the backlight again functions as a plurality of parallel elongate light-emitting strips and the display operates as described hereinbefore and illustrated in FIGS. 2 and 3. The regions 32 not index matched for S-polarised light are preferably narrower than the regions 33 index matched for S-polarised light.

For the single view 2D wide viewing mode of operation, both the light sources 22 and 23 are illuminated. Light from the light source 23 is forward-scattered by the regions 32 as described hereinbefore and light from the P-polarised light source 22 is forward-scattered by the regions 33 (and is not scattered by the regions 32 index-matched to P-polarised light) so as to provide a backlight emitting substantially uniform light across its whole output surface.

The polariser 20 is shown as being oriented so as to be equally transmissive to P and S polarised light. However, the relative brightness can be changed by altering the orientation of the input polariser transmission axis. Such a multiple mode display may be made so as to be relatively thin.

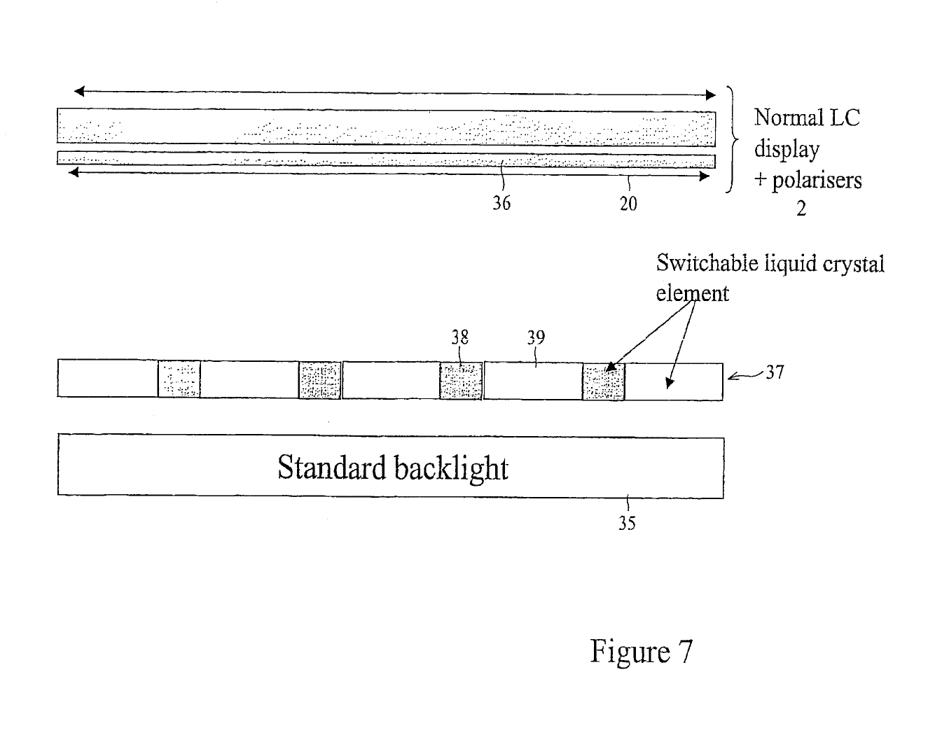

The display shown in FIG. 7 comprises an LCD 2 of type described hereinbefore but having a very thin substrate 36 to allow relatively large image separation for a dual or multiple view display with widely spaced viewing regions. The display comprises a standard or conventional backlight 35, for example of Lambertian type emitting spatially uniform unpolarised light throughout a wide angle across its output surface. A liquid crystal device 37 is disposed between the backlight 35 and the LCD 2 and acts as a switchable “shutter”. The device 37 may be of TFT (thin film transistor type) or it may be of non-TFT type.

The liquid crystal device 37 comprises parallel strip-shaped regions 38 and 39 extending vertically and alternating with each other horizontally. The device 37 is switchable between a multiple view mode, in which the regions 38 transmit light and the regions 39 block light, and a single view mode, in which all of the regions 38 and 39 transmit light. Operation in the two modes is thus as described hereinbefore.

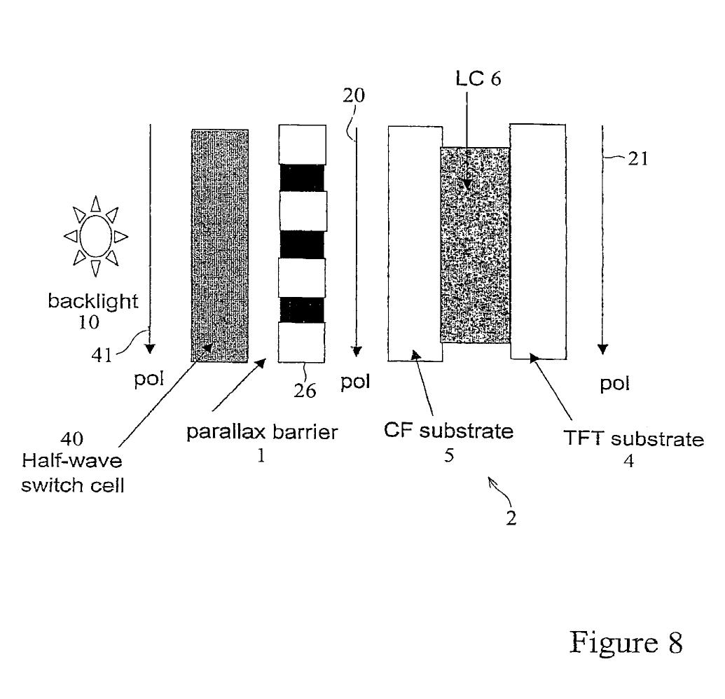

FIG. 8 illustrates a display which operates time-sequentially to provide a dual view display with the first and second images being spatially interlaced or multiplexed in each of a repeating cycle of two time frames. The LCD 2 is arranged to display the images for the two views in spatially multiplexed configuration across its display surface and comprises a colour filter (CF) substrate 5, a thin film transistor (TFT) substrate 4, a liquid crystal (LC) layer 6, an input polariser 20 and an output polariser 21. In this embodiment, the display is of the rear parallax barrier type but may alternatively be embodied as a front parallax barrier display.

In the embodiment of FIG. 8, the colour filter (CF) substrate of the LCD 2 is preferably less than 300 microns thick and may use novel picture element and colour filter arrangements disclosed in co-pending UK patent application No 0420945.8 (published as GB 2418315 in Mar. 22, 2006). Although FIG. 8 shows the CF substrate 5 of the LCD 2 being closer to the parallax barrier element than the TFT substrate 4 of the LCD 2, this may not be the case, and the TFT substrate 4 of the LCD 2 may be closer to the parallax barrier element than the CF substrate 5. The TFT substrate 4 of the LCD 2 is preferably less than 300 microns thick.

The display further comprises a switchable parallax barrier comprising a patterned half wave retarder 26, a switchable half wave cell 40, and a polariser 41 disposed between the cell 40 and a backlight 10, for example of conventional type.

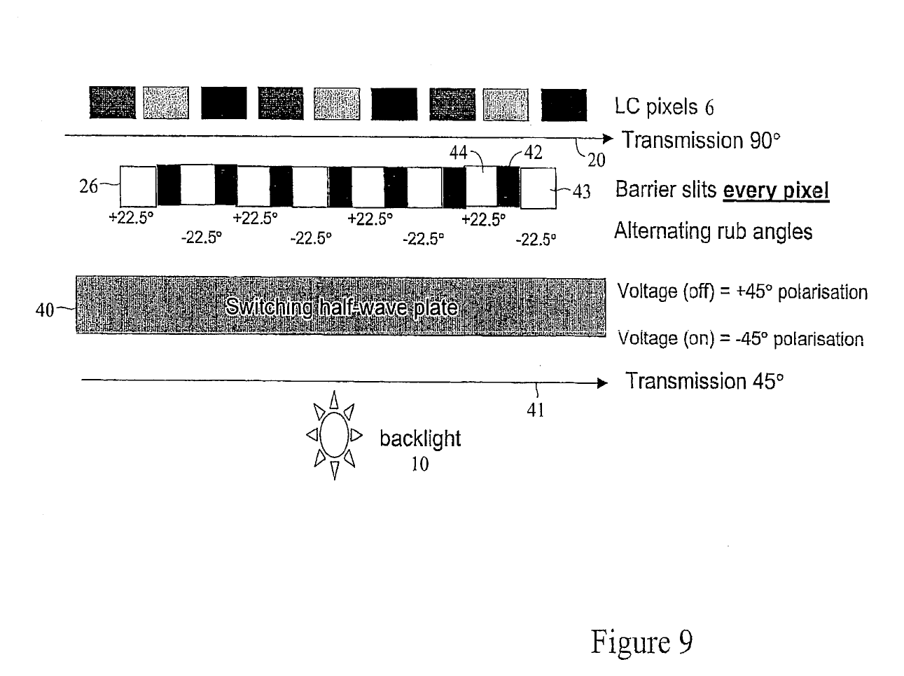

FIG. 9 illustrates various orientations of the elements shown in FIG. 8. The input polariser 20 is arranged so that its transmission axis is oriented at 90° to a reference direction, such as the vertical direction with the display in normal use oriented in a vertical plane. The patterned retarder 26 forming part of the parallax barrier comprises a half wave plate having vertical strips whose optic axes are oriented in different directions and which are separated by light-blocking regions such as 42. The regions such as 43 have their optic axes oriented at −22.5° whereas the regions such as 44 have their optic axes oriented at +22.5°. The cell 40 forms a switching half wave plate whose output polarisation direction is switchable between +45° in the absence of an applied field and −45° in the presence of an applied field across the whole cell.

Nominally unpolarised light from the backlight 10 is polarised by a polariser 41 with a transmission axis at +45°. The polarised light then passes through the switching half-wave plate. In one state (for example the activated state) of the switching half-wave plate, the polarisation state of the incident light is converted to light with polarisation at −45°. In the other state (for example the inactivated state), the incident light polarisation state of +45° is unchanged by the switching half-wave plate.

The light leaving the switching half-wave plate is then incident on the spatially varying patterned retarder element. The alignment direction of the director in the patterned retarder element varies horizontally across the retarder element but is nominally constant vertically. In this example, the director is aligned in a direction of +22.5° in regions 44 and in a direction of −22.5° in regions 43. The director changes direction on a pitch nominally identical to a pixel pitch. (In reality the director will change direction on a pitch slightly larger than a pixel pitch when the retarder element is disposed between the backlight and the image forming display. In the case where the retarder element is disposed between the image forming display and the user, the director will change direction on a pitch that is slightly smaller than a pixel pitch. It will be apparent to those skilled in the art that the director does not have to change direction on a pitch nominally equal to a pixel pitch (as shown in FIG. 9) but may change direction on a pitch nominally equal to an integral multiple of a pixel pitch.)

The patterned retarder 26 may be in the form of a fixed liquid crystal device. The orientation of the optic axes of the strips 43 and 44 may be defined by one or two alignment layers of different alignment or rubbing directions. The substrate 5 may be relatively thin, for example of less than 300 microns thickness.

As discussed previously, image mixing is severe in the case of dual-view displays, and is particularly bad in the case of dual-view displays for an automotive environment. The patterned retarder element may have opaque material in vertical columns or stripes between a region where the director is in nominally one orientation and another region where the director is in a different alignment direction. The opaque material is used to reduce the image mixing. In some cases the opaque material may be replaced with reflective material. The advantage in this case is that light is not absorbed but rather can be reflected and recycled in order to improve the overall display brightness.

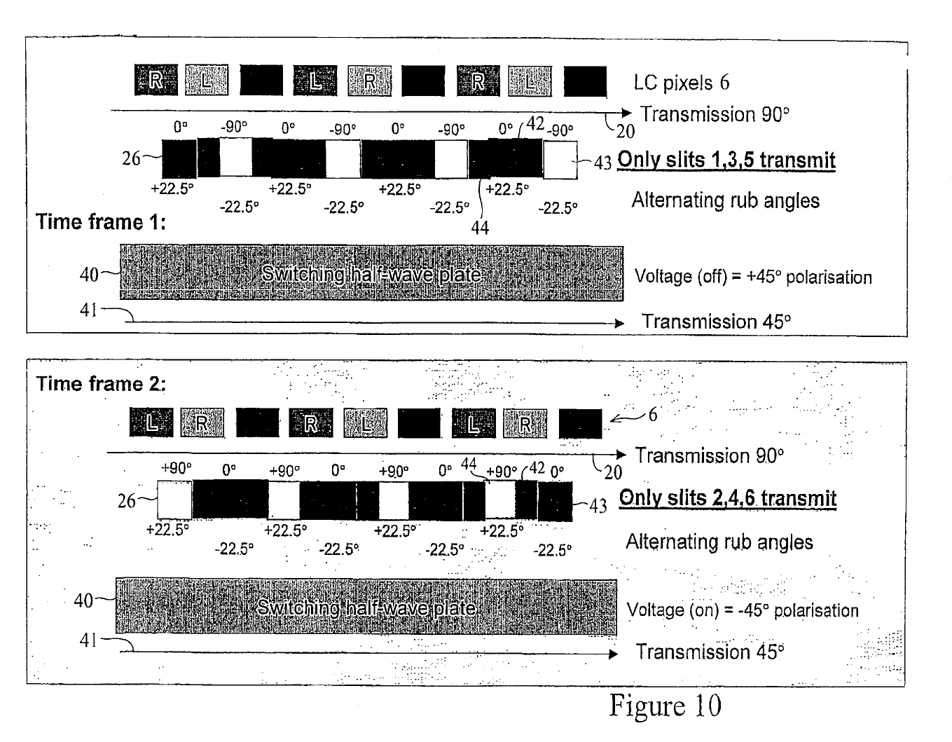

FIG. 10 illustrates the operation of the display shown in FIGS. 8 and 9 during time frame 1 and time frame 2 of a repeating cycle of two time frames. In the first time frame of each pair as illustrated in the upper part of FIG. 10, the switching half wave plate is not activated. The light leaving the switching half wave plate thus has a polarisation nominally identical to the polarisation state of the light incident on the half-wave plate so that light of nominally +45° polarisation is incident on the patterned retarder element. The incident light, the patterned retarder and the rear polariser of the image forming display co-operate to form a light distribution of finite horizontal extent but nominally infinite vertical extent. Light passing through the strips 43 has its polarisation direction changed to −90° and is thus transmitted by the polariser 20 whereas light passing through the regions 44 has its polarisation direction changed to 0° and is blocked by the polariser 20. The retarder 26 thus acts as a parallax barrier with the slits being provided by the regions 43 and cooperates with the spatially multiplexed first and second images such that they are visible in the first and second viewing regions, respectively. The image forming display puts one image (image 1) on one group of pixels (group 1) and a separate image (image 2) on another group of pixels (group 2). Both groups of pixels are spatially multiplexed. The spatial multiplexing may be arranged so that the interlacing pattern is sub-pixel n of group 1 followed by sub-pixel n of group 2 followed by sub-pixel (n+1) of group 1 and so on. Alternatively, two or more sub-pixels of one particular group may be adjacent. For example, the interlacing pattern may be sub-pixel 1,2,3 of group 1 followed by sub-pixel 1,2,3 of group 2 followed by sub-pixel 4,5,6 of group 1 etc.

In FIG. 10 time frame 1, group 1 pixels are observed from a left viewing region (region 1). Group 2 pixels are observed from a right viewing region (region 2). Therefore a driver in region 1 views image 1 and a passenger in region 2 views image 2.

In the second time frame of each pair, the pixels which displayed the left image in the previous time frame now display the right image whereas the pixels which displayed the right image in the previous time frame now display the left image. A voltage is applied to the cell 40, which causes it to act as a half wave plate for light polarised at 45° by the polariser 41 so that light travelling from the cell to the retarder 26 is polarised at −45°. The regions 43 now changed the polarisation direction to 0° whereas the regions 44 change the polarisation direction to +90°. Thus, light passing through the regions 43 is blocked by the polariser 20 whereas light passing through the regions 44 is passed by the polariser 20. The retarder 26 thus functions as a parallax barrier with the regions 44 forming the transmissive slits so that the positions of the slits are different in the second time frame. The repositioned slits cooperate with the spatial multiplexing of the left and right images by the pixels 6 such that the first and second images are again visible in the first and second viewing regions, respectively.

In time frame 2, the switching half-wave plate is activated and the polarisation state of the light exiting the switching half-wave plate is rotated 90 degrees and is nominally −45°. This has the affect of horizontally displacing the light distribution pattern of finite horizontal extent by nominally one pixel pitch (this is the case shown in FIG. 10, but it is apparent to those skilled in the art that the displacement of the light distribution pattern may be nominally an integral multiple of the pixel pitch). In time frame 2, the image forming display shows image 1 on group 2 pixels and image 2 on group 1 pixels. In this case, viewing region 1 can see group 2 pixels whereas viewing region 2 sees group 1 pixels.

In this way a driver positioned in viewing region 1 always sees image 1 and a passenger in viewing region 2 always sees image 2. However, owing to the horizontal displacement of the light illumination pattern and the switch in the interlacing pattern, the driver and the passenger can observe each image at the native resolution of the image forming display. This method to generate a full resolution image to each viewer by time multiplexing a spatially multiplexed display leads to better image quality (less flickering) than a temporally multiplexed system where one frame is delivered to one viewer and the subsequent frame is delivered to a different viewer.

Thus, all of the pixels 6 of the LCD 2 display both images in each pair of time frames and the first and second images are visible only in the first and second viewing regions, respectively. The apparent spatial resolution of each of the images is thus improved compared with a non-time-sequential display and each image is displayed in each time frame as compared with a conventional time-sequential display. The image quality for each viewer is thus improved.

In FIG. 10, although the elements of +22.5° and 22.5° are fixed, they are effectively transmissive in alternate time frames so that the transmissive slits, and hence the parallax elements, switch between the positions of these two sets of elements.

In FIGS. 8-10, if image 1 is identical to image 2, each viewer sees the same image at the basic resolution of the image forming display and this mode functions as the 2D mode of the display.

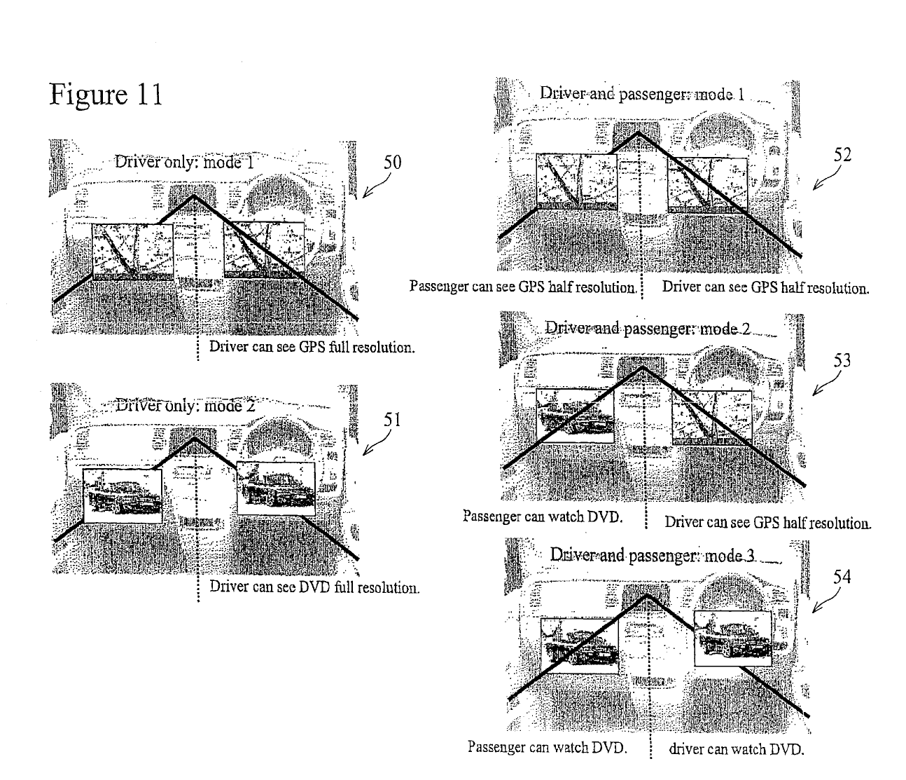

In the embodiment shown in FIG. 11, a sensor monitors the presence of a passenger in the car. This may be achieved in a number of ways. If the driver only is present in the car, the display automatically has a default 2D full resolution mode. If the keys are placed in the ignition or if the engine is activated or if the car is moving, mode 1 is operated whereby the driver can only see safety or GPS information in full resolution as shown at 50. If the car is stationary, or the ignition keys are removed, the driver can watch other content in full resolution 2D as shown at 51. The sensor senses when a passenger is present and automatically switches the display to a dual-view mode 1 as shown at 52. Of course, the passenger can then select other content (mode 2) as shown at 53. Again, if the car is in a stationary state, both driver and passenger can experience varied content (mode 3) as shown at 54. Many cars are now equipped with sensors to monitor if a child seat is present in the car. Additionally or alternatively, a car may be equipped with a sensor to monitor whether a child passenger (without child seat) is present in the car. In this case, the dual-view mode is again automatically activated but the default position is to show appropriate content for the child passenger. There may also be a filter present to allow only suitable content to be shown to the child passenger.

Additionally or alternatively to suitable content being shown to the child passenger, but the menu for the child passenger may default to the most used content choice (e.g. DVD or on-line games or education webpages).

A further variation of this embodiment combines an in-car camera system with a dual-view display. Imaging systems are becoming more common place in an automotive environment to provide safety features, for example by monitoring the driver's blink frequency or gaze direction and alerting the occupants if it is believed the driver is becoming too drowsy to operate the vehicle safely. Similar imaging systems are being proposed also as security features. For example, face recognition software is activated on the captured image of the driver and compares the captured image with images stored in memory corresponding to permitted drivers of the vehicle. This type of imaging system could also be used to monitor the passenger present. In this case the display will switch to dual-view mode if it determines that a passenger is present. However, the content options for the passenger will default to those most commonly used by that passenger. For example, passenger 1 may watch DVD content most frequently whereas passenger 2 uses the Internet on a more frequent basis. The image system could not only identify that a passenger is present, but could also identify which of passenger 1 and passenger 2 is present and default to their normal preference e.g. DVD menu for passenger 1 and web browser for passenger 2.

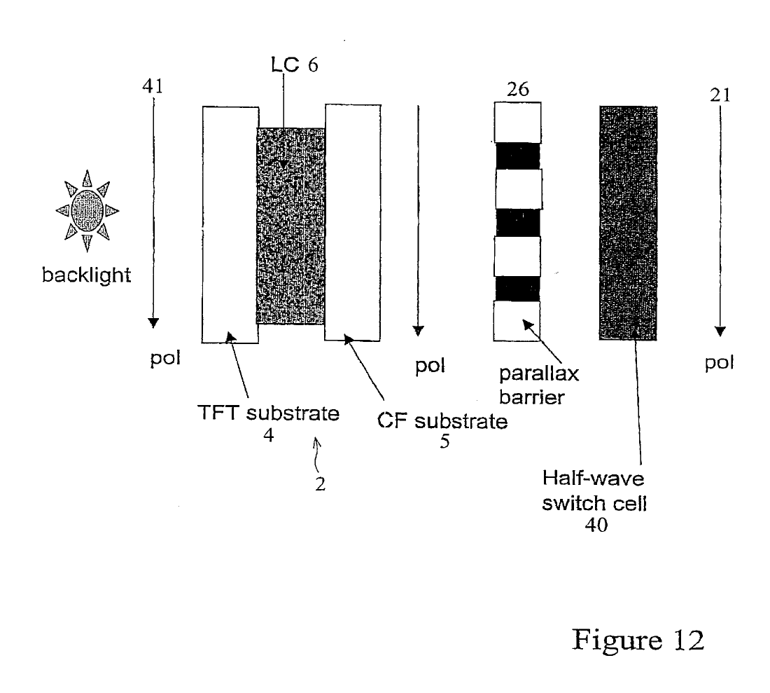

FIG. 12 shows a further display according the present invention. The display of FIG. 12 is generally similar to the display of FIG. 8 except that the order of the components is different. In the display of FIG. 12 the patterned retarder element 26 is disposed between the image display device 2 and the user.

In the embodiments of FIGS. 8, 9, 10 and 12, the exact orientation of the elements may not be those described but may have alternatives which are obvious to those skilled in the art.

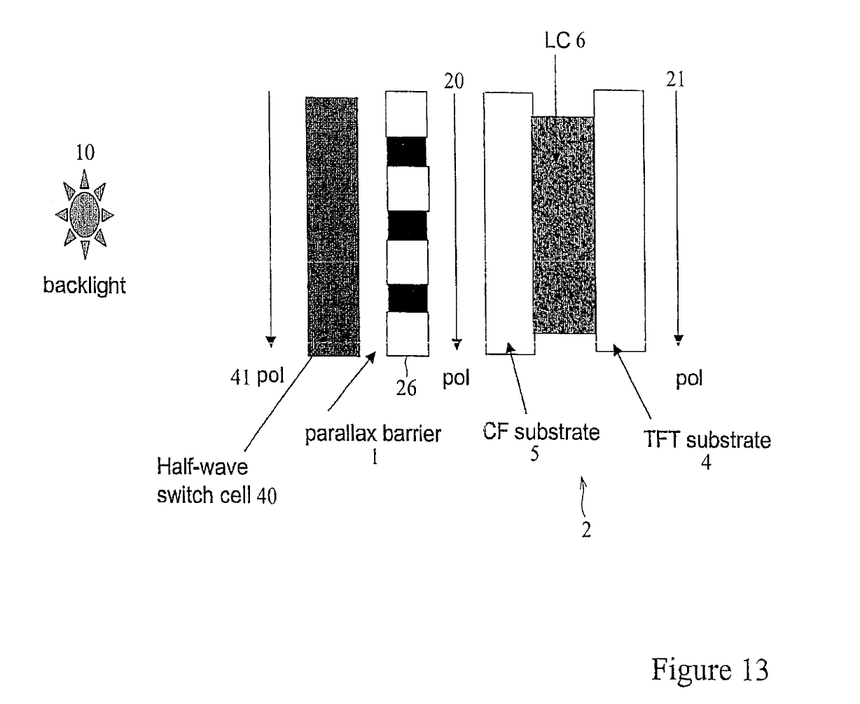

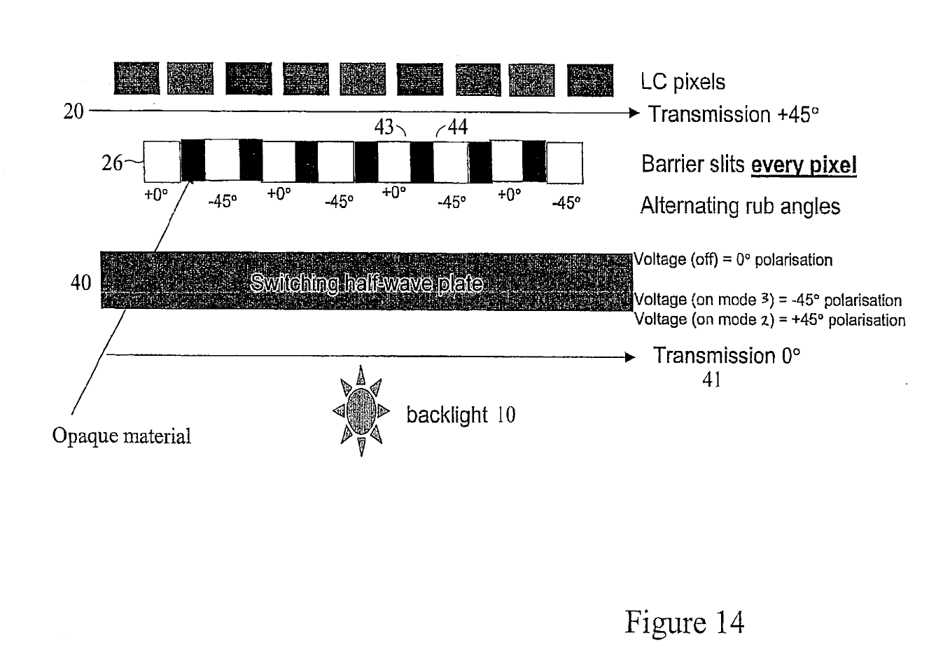

FIGS. 13 and 14 show a further display of the present invention. This embodiment is again generally similar to that of FIG. 8, but, in this case, the switching half wave plate has 3 possible effects on the incident polarisation: (1) no effect; (2) rotation of the plane of polarisation of incident light by +X° and (3) rotation of the plane of polarisation of incident light by −X°. In a preferred embodiment, as shown in FIG. 14, state (1) is obtained for no applied voltage, state (2) provides a rotation of +45° of the polarisation and state (3) provides a rotation of −45° of the polarisation. States (2) and (3) are obtained by applying suitable voltages to the half-wave plate.

The patterned retarder 26 of FIG. 14 is generally similar to the patterned retarder of FIG. 9, except that optic axes of the strips 43 and 44 are aligned at 0° and 45° to the reference direction.

In FIG. 14 it can be understood that a true 2D mode of the display (rather than a time multiplexed 2D mode as described with reference to FIG. 10) is obtained when the switching half wave plate is set to have no effect on the incident polarisation. This has the advantage that no time multiplexing is used to reclaim the full basic resolution of the image forming display and therefore image quality is improved due to reduced image flickering.

In FIG. 14, the full-resolution dual-view mode is obtained by temporally switching the half-wave plate 40 between the mode (3) voltage which provides a rotation of −45° of the polarisation, and the mode (2) voltage which provides a rotation of +45° of the polarisation. The performance of this dual-view mode is nominally identical to the dual-view mode of the display of FIG. 10.

In the display of FIGS. 13 and 14, the parallax barrier 1 (constituted by the switching half wave plate 40 and the patterned retarder 26) may alternatively be disposed between the image display device 2 and an observer.

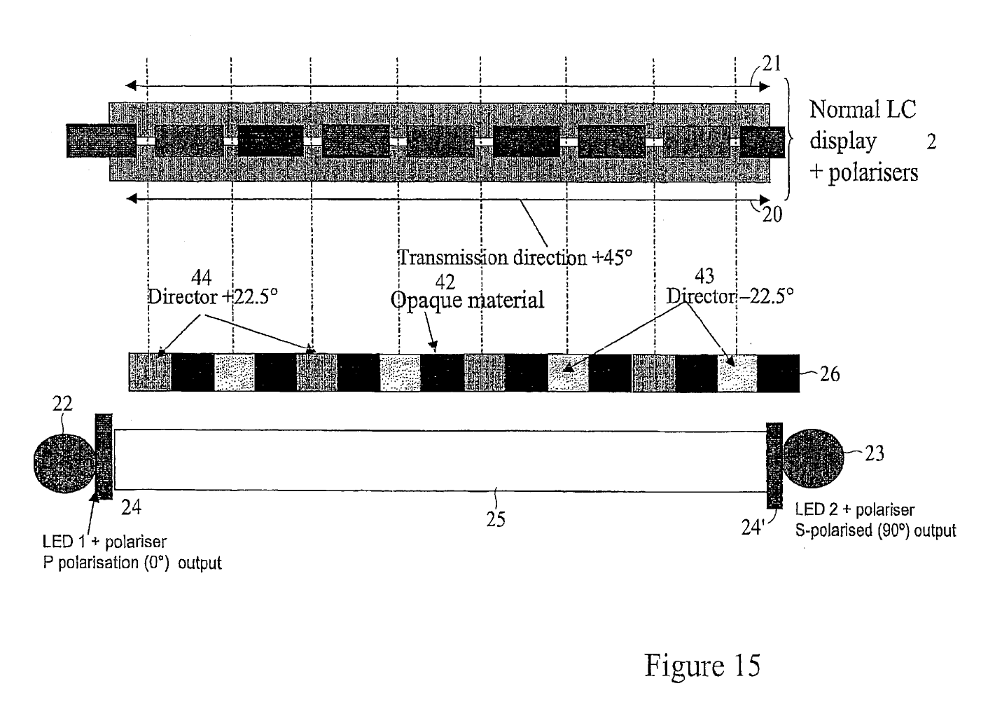

FIG. 15 shows a further display of the invention. The effect of this embodiment is nominally identical to that of the display shown in FIGS. 9 and 10. The elements in FIG. 15 are very similar to those disclosed in FIG. 5, except that the patterned retarder 26 of FIG. 15 corresponds generally to the patterned retarder of FIG. 9.

The spatially varying patterned phase retarder element 26 is placed adjacent a polarisation preserving backlight waveguide 25. In this case the backlight waveguide 25 can couple light from 2 separate light sources 22,23 whose output polarisation states are different. In FIG. 15 the different output polarisation states are provided by polarisers 24,24′ disposed in front of each light source 22,23, but in principle light sources that emit polarised light could be used. The light sources 22,23 may be, for example, LEDs. The polariser 24 associated with the first light source 22 has its transmission axis arranged at a non-zero angle, preferably substantially at 90°, to the transmission axis of the polariser 24′ associated with the second light source 23.

In time frame 1, the first light source 22 (LED1) is illuminated and the other light source 23 (LED2) is not activated. The light from the first light source 22 (LED1) passes through the patterned phase retarder 26 which imposes a spatially varying phase distribution on the light incident on the rear polariser 20 of the image display device 2 which (in this example) has nominally full transmission for light polarised at +45 degrees to a reference direction (which may be, for example the vertical direction when the display is in normal operation and oriented vertically). This generates a spatially varying light intensity distribution of nominally infinite vertical extent but limited or finite horizontal extent.

When the second light source 23 (LED2) is illuminated and the first light source 22 (LED 1) is deactivated, a spatially varying light intensity distribution of finite horizontal extent is again created but horizontally displaced compared to the case when the first light source 22 (LED1) is illuminated and the second light source 23 (LED2) is inactive. When the second light source 23 (LED2) is illuminated, the spatial multiplexing of the images on the image forming display is effectively swapped as described previously. In this way each viewer of the dual-view display sees a separate image of effectively full resolution due to the time multiplexing.

In the dual-view mode of operation, two separate images are then displayed via spatial multiplexing on the image forming display. Full resolution dual-view mode can be achieved by time multiplexing the illumination of the first and second light sources and also time-multiplexing the spatial interlacing of the images on the image forming display. To switch to a 2-D display mode of the display, the time multiplexed illumination or activation of LED1 and LED2 is again carried out but this time an identical image is obtained overall for each viewer of the display.

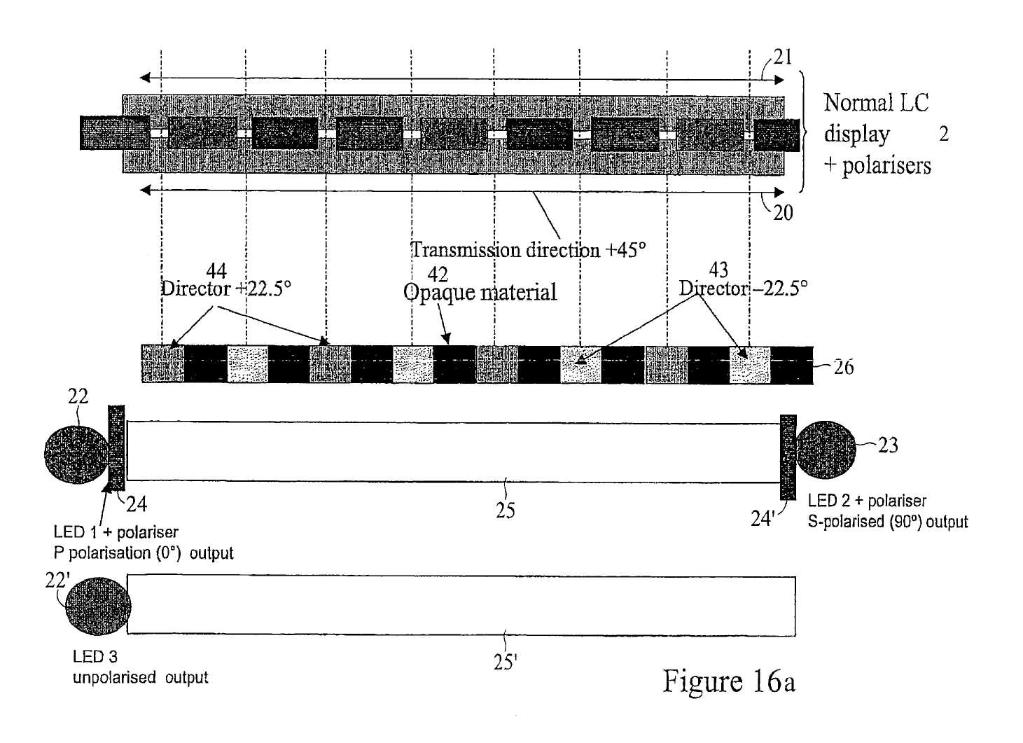

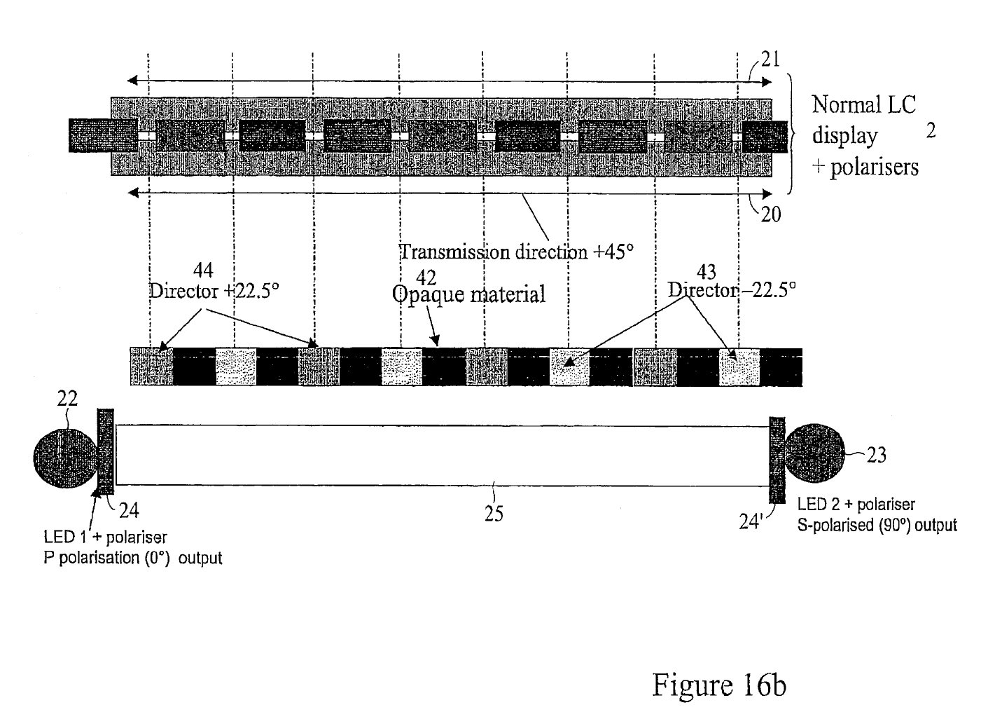

FIG. 16a shows a further display according to an embodiment of this application. The display of FIG. 16a corresponds generally to the display of FIG. 15, except that the display of FIG. 16a comprises a second backlight waveguide 25′ that receives light from a third light source 22′, which may be, for example, an LED. The third light source 22′ provides unpolarised light. When the third light source 22′ (LED3) is illuminated and the first and second light sources 22,23 are not illuminated, a full-resolution 2D mode of the display may be obtained without time multiplexing. A full-resolution dual-view mode by time multiplexing can be achieved by time-multiplexing the illumination of the first and second light sources 22,23 (LED1,LED2) as described for FIG. 15. For the full-resolution dual-view mode by time-multiplexing, the third light source (LED3) would be inactive.

FIG. 16b shows a simpler embodiment where the third light source 22′ (LED3) and the second waveguide 25′ are omitted and the 2D mode is achieved by simply illuminating both the first light source 22 (LED1) and the second light source 23 (LED2) simultaneously. (Although the display of FIG. 16b contains the same components as the display of FIG. 15, their operation is different.)

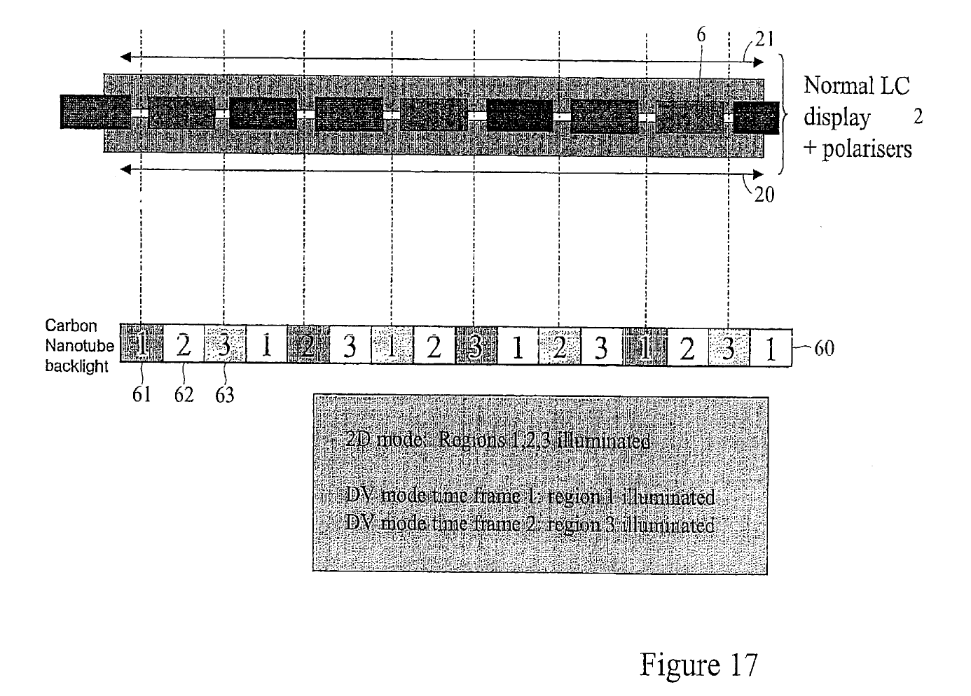

FIG. 17 shows a display according to another embodiment of this invention. The display has a image display device 2, which may be, for example, a liquid crystal image display device 2 having liquid crystal pixels 6 disposed between polarisers 20,21. The image display device 2 is illuminated by a backlight 60. The backlight 60 has independently controllable illuminated regions 61-63, which preferably have the form of stripes extending into the plane of the paper. In this embodiment, the position or horizontal extent of the illuminated regions (stripes) 61-63 may be varied to allow switching between a conventional 2D state without time-multiplexing and a full-resolution dual-view mode with time multiplexing.

The backlight 60 of FIG. 17 may be an emissive backlight, in which the regions 61-63 are emissive regions. As an example, the backlight 60 may be a carbon nanotube backlight (see for example http://www.sid.org/chapters/uki/displaysearch.pdf), or alternatively the backlight 60 may be an organic LED backlight with patterned electrode structure or planon CCFL (cold cathode fluorescent light) with suitable rib structure to separate the regions 61-63.

In FIG. 17, the full-resolution 2D mode is achieved by illuminating all regions 61-63 in the backlight nominally simultaneously. A single image is displayed on the image display device 2, and the display operates as a conventional 2-D display. When a dual-view or multi-view mode is required, during time frame one of a repeating cycle of two time frames only regions 61 are activated, and then only regions 63 are activated in the second time frame of the cycle. First and second images are displayed on the image display device 2, in a spatially multiplexed manner. In a similar way to that described previously, careful control or synchronisation of the spatially multiplexed images with the time multiplexing of the backlight regions will result in a full-resolution dual-view or multiple view display mode with improved image quality due to reduced flickering compared to a full frame sequential time multiplexing system. Further the image quality of the time multiplexed dual-view mode is improved compared to the fixed or static reduced resolution dual-view display since the spatial frequency of the dark vertical lines in the “effective parallax barrier” is increased in the time multiplexed case. The pitch from regions 61-63 should be nominally equivalent to one sub-pixel pitch or an integral multiple of a sub-pixel pitch of the image forming display. However it will be obvious to those skilled in the art that in reality, since the “effective parallax barrier” is further from the user than the image forming display, the pitch 61-63 is slightly larger than one sub-pixel pitch or integral multiple of the sub-pixel pitch.

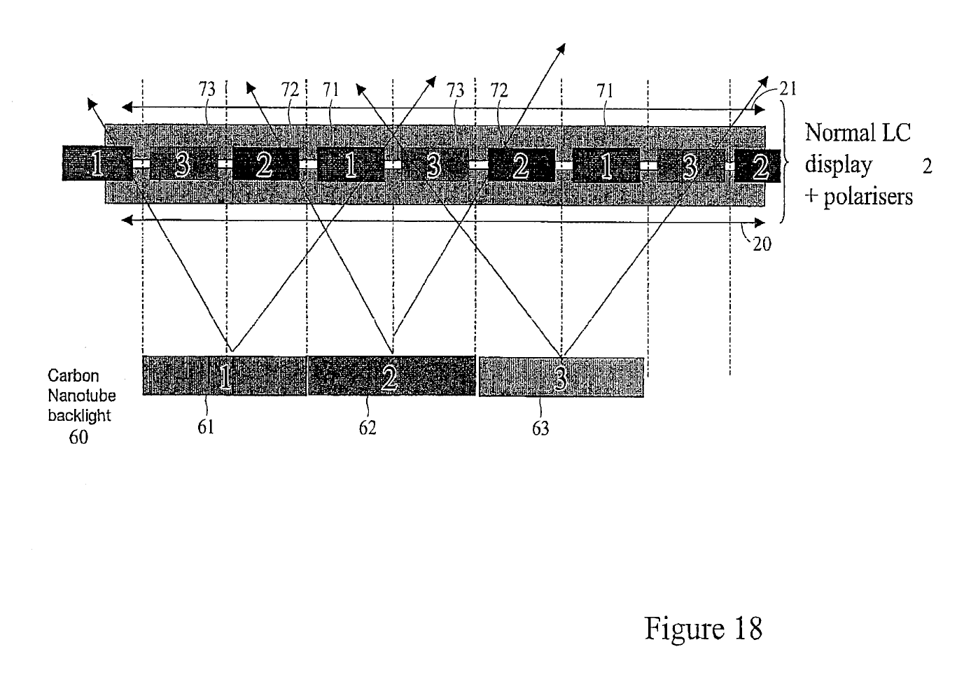

FIG. 18 shows a further display according to the invention. The display has a image display device 2, which may be, for example, a liquid crystal image display device 2 having liquid crystal pixels 6 disposed between polarisers 20,21. The image display device 2 is illuminated by a backlight 60. The backlight 60 has independently controllable illuminated regions 61-63, which preferably have the form of stripes extending into the plane of the paper.

The image display device can display a colour image and comprises pixels of at least two colours. The regions 61-63 of the backlight 60 each emit light of a respective wavelength range. The image display device 2 is preferably a full-colour display, and the regions 61-63 of the backlight 60 preferably emit red light, blue light and green light. Ideally the spectral width of the emission from each individual region is narrow.

The backlight 60 of FIG. 18 may be an emissive backlight, in which the regions 61-63 are emissive regions. As an example, the backlight 60 may be a carbon nanotube backlight with spatially patterned phosphor stripes, each pattern ideally emitting one of either red light, blue light or green light. Alternatively the backlight 60 may be an organic LED backlight with patterned material structure, each material ideally emitting one of either red light, blue light or green light, a planon CCFL (cold cathode fluorescent light) with patterned colour phosphor stripes, or a conventional CCFL or white LED backlight with a striped colour selective means on the emitting surface of the backlight waveguide.

In FIG. 18, the output emitting phosphors of the carbon nanotube backlight are arranged in stripes that extend into the plane of the paper, and that thus are vertical when the display is in use in its normal orientation. The stripes of the output emitting phosphors define the illuminated regions 61-63 of the backlight. The width of each region 61-63 of the backlight is nominally equal to twice the pixel pitch of the image display device 2.

The transmissive colour filters 71-73 of the image display device are composed of 3 separate pass bands. One pass band is for green light, one pass band is for red light and one pass band is for blue light. The spectral pass band of either the red, green or blue colour filter on the liquid crystal image forming device ideally corresponds to only one of the spectral profiles of the emitting stripes on the backlight.

Therefore in FIG. 18, it is shown that stripes 61 on the backlight emit only red light. Therefore, this light can pass through only colour filters of type 71 of the image display device. Similarly stripe 62 on the backlight emits only blue light and this light is transmitted only by colour filters of type 72 on the liquid crystal image forming display. Similarly stripe 63 on the backlight emits only green light and this light is transmitted only by colour filters of type 73 on the liquid crystal image forming display. The backlight 60 in FIG. 18 therefore has to be aligned carefully with the image display device 2 to ensure that viewing regions are set up in desired locations. The spatial light modulator and the backlight are arranged such that light output from the one region of the backlight along a predetermined axis of the display is not incident on a region of the spatial light modulator that is transmissive to that light, and this sets up viewing windows on either side of the predetermined axis.

The predetermined axis may be, as shown in FIG. 18, the normal axis of the display. It can be seen in FIG. 18 that the colour filters disposed directly in front of an emissive region of the backlight do not transmit light from that region of the backlight. Thus, green and blue colour filters 72,73 are disposed in front of a red emissive region 61 of the backlight, and so. Light from the backlight is therefore not transmitted along the normal axis of the display, but is directed into viewing zones disposed on either side of the normal axis, thus providing a dual view or multiple-view display mode.

The arrangement in FIG. 18 can lead to a dual-view display with very low levels of image mixing as well as a dark central window between images. It can also result in excellent head freedom for either viewer.

The embodiment of FIG. 18 is intended to have the advantage that there is, at least theoretically, no crosstalk between the adjacent viewing regions. This is achieved by making the width of each colour component emitting strip of the backlight less than or equal to the gap between adjacent pairs of columns of pixels modulating the same colour component. If the width of the backlight strip were greater than this gap, then the pair of pixel columns, which display spatially interlaced strips of different views, would modulate light which mixed in an overlapping pair of viewing regions in front of the display. An observer in the overlapping region would therefore see both images or views. The width constraint is such as to prevent this.

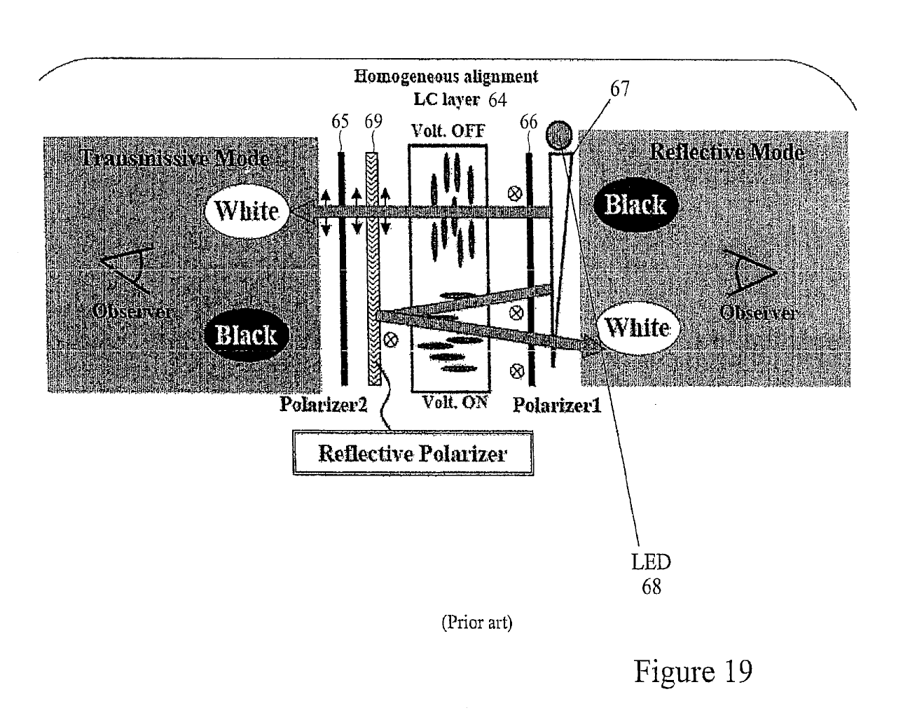

FIG. 19 summarises the operation of a prior-art “dual-faced” LCD as disclosed by Sharp Corporation, in Taguchi, Proceedings of International Displays Workshop 2004, paper LCT4-3. This dual-faced LCD can operate in either full area transmissive mode or full-area reflective mode. The LCD comprises a liquid crystal layer 64 disposed between a first polariser 65 and a second polariser 66. The LCD further has a waveguide 67 arranged to receive light from an LED 68 or other light source. The LCD further comprises a reflective polariser 69, which is disposed between the liquid crystal layer 64 and one of the first and second polarisers. In normally white mode, the display operates in transmission with the LED 68 and waveguide 67 acting as a backlight. In normally black mode, the display operates in reflective mode with the LED 68 and waveguide 67 acting as a frontlight.

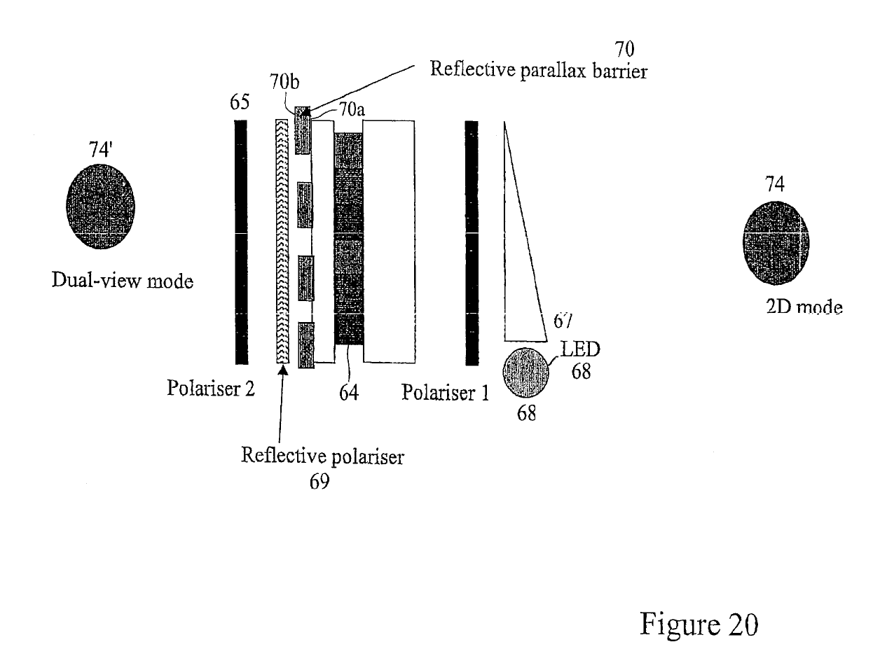

FIG. 20 shows a display that is a modification of the prior art “dual face” display of FIG. 19. The display of FIG. 20 is switchable mechanically between a full-resolution 2D state and a fixed or static, reduced resolution dual-view mode.

In FIG. 20, a reflective parallax barrier 70 has been added to the dual-faced LCD of FIG. 19. This barrier is ideally reflective (with a diffuse reflection) on the surface 70a closest to the illumination source 68, whereas the surface 70b of the parallax barrier further from the illumination source is ideally opaque. This can be achieved simply by coating the reflective parallax barrier with an absorbing material (e.g. dye doped photosensitive polymer) on the surface further from the illumination source 68.

When the display is viewed by an observer 74 on the same side of the display as the light source 68 a 2-D mode is obtained. In the 2D mode of operation the LED and waveguide act as a frontlight. Light from the light source 68 is directed over the area of the display by the waveguide 67, and is reflected to the observer 74 either by the reflective parallax barrier 70 or by the reflective polariser 69.

When the display is viewed by an observer 74′ on the opposite side of the display from the light source 68 the parallax barrier 70 acts as a conventional front parallax barrier and a dual view mode is obtained. Thus, the display of FIG. 20 may be mechanically switched between a 2-D (reflective) display mode and a dual view (transmissive) display mode by rotating the display through approximately 180° about its vertical axis (or about a horizontal axis, although in this case the display as seen by an observer in one mode would be inverted compared to the display as seen by that observer in the other mode, and addressing of the image display layer 64 would need to take account of this).

The display of FIG. 20 is not limited to the specific ordering of elements shown in FIG. 20 and alternative orderings will be obvious to those skilled in the art.

In an automotive environment, the display device in FIG. 20 may only operate in 2D mode when only the driver is present in the car. In this way the driver can obtain safety or GPS information at full-resolution. Naturally non-safety or non-GPS content will still not be available to the driver. When a passenger is present, the display can either operate in 2D mode or dual-view mode. Again in 2D mode only safety or GPS content would be available. However if the passenger wanted to see other content (such as DVD or internet), the display would have to be rotated 180 degrees to work in transmissive mode. In this mode, dual-view is again possible and the passenger can watch non-safety content while the driver can still access safety or GPS information.

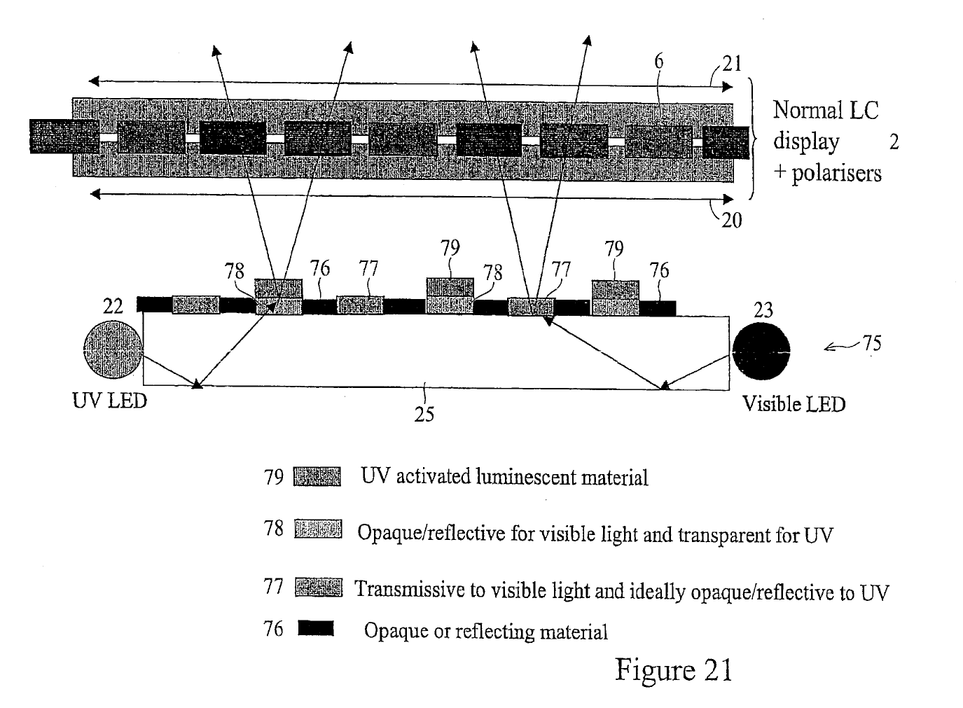

FIG. 21 shows a further display according to the invention. The display has a image display device 2, which may be, for example, a liquid crystal image display device 2 having liquid crystal pixels 6 disposed between polarisers 20,21. The image display device 2 is illuminated by a backlight 75.

The backlight 75 has a backlight waveguide 25 that is arranged to receive light from two independently controllable light sources 22,23 that emit light in different regions of the spectrum from one another. The first light source 22 emits light ideally in a narrow spectrum centred at less than 410 nm and may for example be an LED that emits in this wavelength range. The second light source 23 ideally emits a broad spectrum of light in the visible region of the spectrum, preferably with little light emitted either at wavelengths below 410 nm or at wavelengths greater than 670 nm. The second light source 23 may again comprise one or more LEDs.

The backlight waveguide 25 in FIG. 21 has a repeat pattern of three stripes of material, preferably disposed on the emitting side of the waveguide. The stripes have infinite extent into the plane of the paper in FIG. 21 (i.e. in the vertical direction when the display is in use in its normal orientation) but limited horizontal extent. Each first stripe 76 either absorbs or reflects both UV and visible light. Each second stripe 77 is transmissive for visible light and ideally reflecting or absorbing for UV light. Each third stripe 78 is transparent for UV and reflective or absorbing for visible light. Disposed on top of each third stripe 78 is a fourth material 79 which is a UV activated luminescent (either fluorescent or phosphorescent) material (preferably activated by light having a wavelength of less than 410 nm).

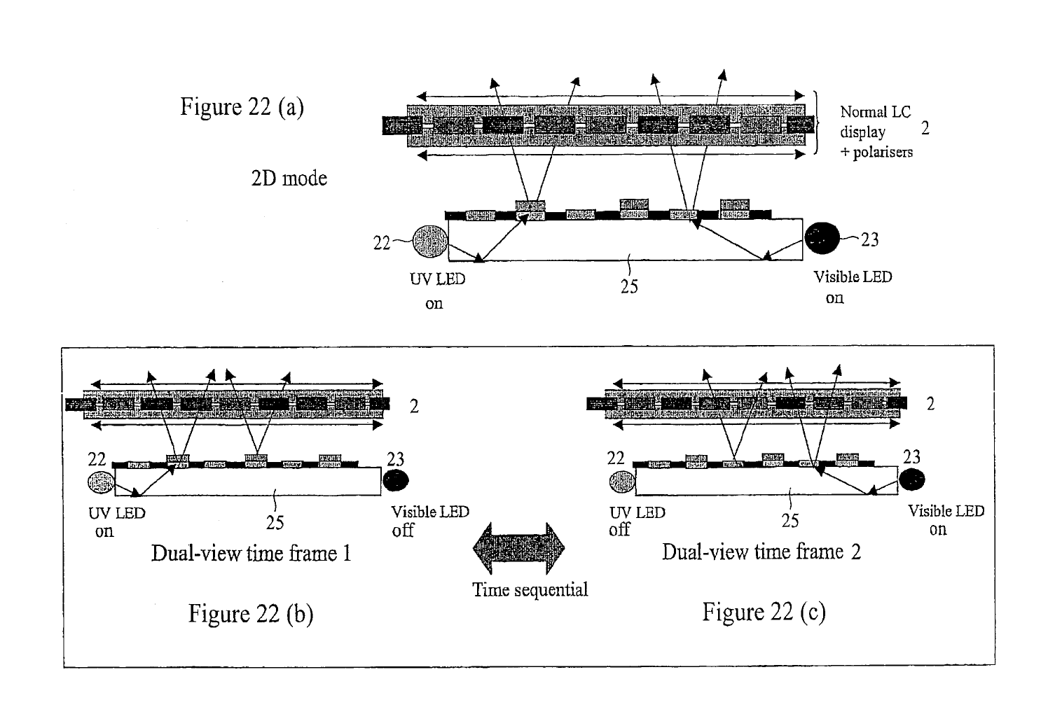

FIGS. 22(a) to 22(c) describe in more detail how a full resolution 2D mode and also a dual-view mode can be realised. In FIG. 22(a), the 2D mode is achieved without time multiplexing by turning on both light sources 22,23 simultaneously. The dual-view mode is again, like some previous embodiments, achieved by illuminating one light source only in one time frame as shown in FIG. 22(b) and by illuminating the alternate light source only in the second time frame as shown in FIG. 22(c). In time frame 1 in FIG. 22(b), the regions 79 of UV activated luminescent material are illuminated with UV light from the first light source 22, and so are caused to emit visible light. However, the second stripes 77 do not emit light, since they are absorbing or reflective for the light emitted by the first light source. In time frame 2 in FIG. 22(c), the regions 79 of UV activated luminescent material are not illuminated with UV light from the first light source 22, and so do not emit visible light. However, the second stripes 77 emit light, since they are transmissive for the light emitted by the second light source 23. Thus, by alternating the illumination of the light sources (and coordinating with this the correct image interlacing pattern and image location), a full resolution dual-view mode can be realised.

Owing to the light illumination colour balance being potentially different between time frame 1 and time frame 2 in FIGS. 22(b) and 22(c), the images displayed in the image forming display may have colour compensation so that little colour difference between each time frame image is noticed by the user.

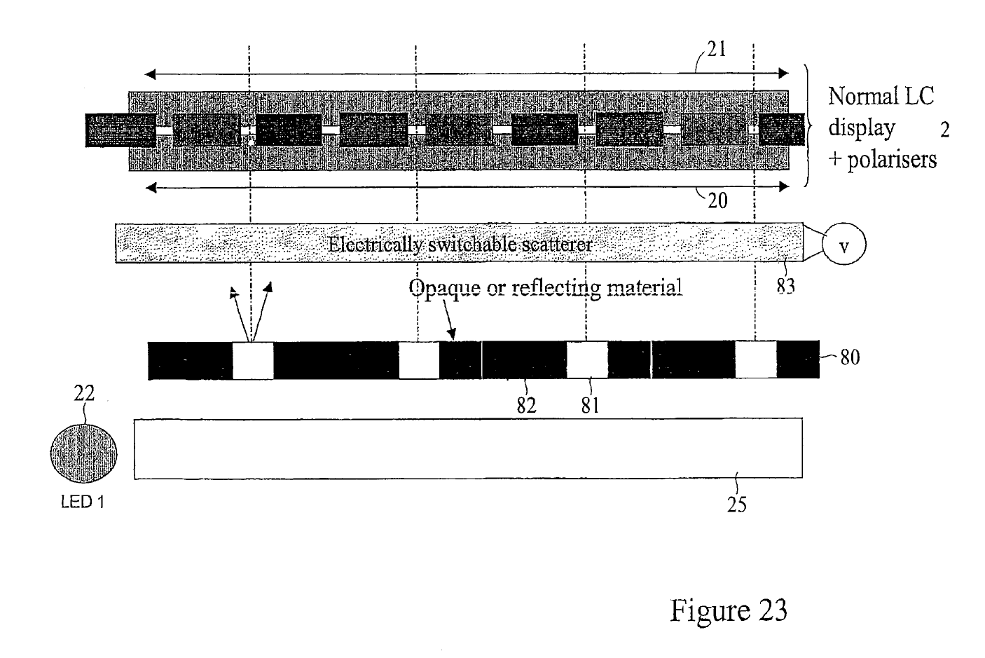

FIG. 23 shows a further display of the present invention. A image display device 2, which may be an LCD image display device having an LC layer disposed between first and second polarisers 20,21 is illuminated by a backlight. The backlight comprises a light source 22, for example an LED light source, and a backlight waveguide 25 arranged to accept light from the light source. The backlight is positioned on the opposite side of the image display device from the user.

A parallax barrier 80 is disposed between the backlight waveguide 25 and the image display device 2. Preferably, the areas 82 between the transmissive apertures 81 of the parallax barrier 80 comprise a reflective material, but they may alternatively comprise a light-absorbing material. The transmissive apertures 81 of the parallax barrier preferably extend into the plane of the paper in FIG. 23 and so have the form of vertical slits when the display is in use in its normal orientation. Disposed between the parallax barrier 80 and the image display device 2 is an electronically switchable scattering material 83, such as a polymer dispersed liquid crystal. The scattering material 83 can be switched electrically between a nominally fully transmissive low scattering state and a less transmissive, highly scattering state.

The 2D mode of operation of the display of FIG. 23 has the switchable scattering material 83 in a scattering state and this gives the effect that the backlight has nominally both infinite vertical and horizontal extent. The dual-view mode of operation has the switchable element in the nominally fully transmissive, low scattering state. In this case, the parallax barrier structure is preserved as light is transmitted through the scattering material 83 and a dual-view mode results.

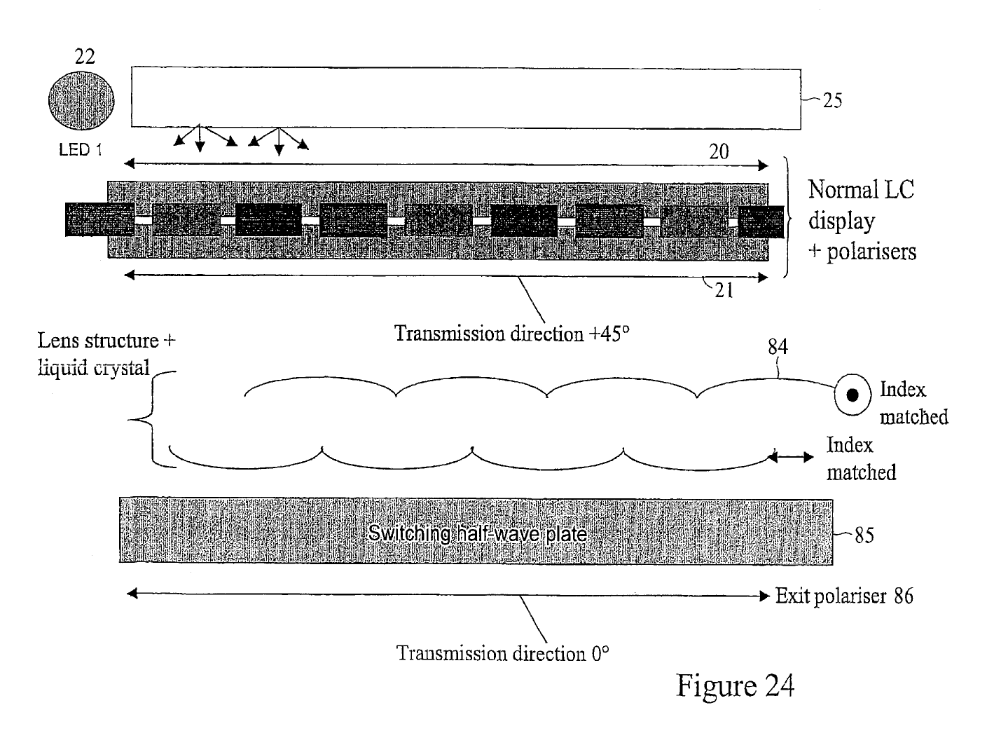

FIG. 24 shows a display according to a further embodiment of the invention. This display has an image display device, for example an LC image display device having a liquid crystal layer disposed between first and second polarisers 20,21, which is illuminated by a light source 22 and backlight waveguide 25.

The light exiting the image display device 2 is polarised by the exit polariser 21 of the image display device, in this embodiment at +45° to a reference direction (such as the vertical direction with the display in normal use oriented in a vertical plane). This light is then incident on a polarisation sensitive lens structure 84 forming lenticular lens with the lens function operating horizontally. These lens structures comprise a substrate with surface relief and a birefringent material such as a liquid crystal. The first substrate is made from material 1 and is index matched for light which is polarised at a first angle (in this example 90 degrees) to the reference direction. The second lens substrate is made from material 2 and is index matched for light which is polarised at a second angle (in this example 0°) to the reference direction). Although this example has both substrates made from a different material, the invention is not limited to this configuration and it is clear to those skilled in the art that, for example, the substrates can be identical but the material used to make the surface profile lenses could be different. The lens structures image the pixels of the image forming LCD into viewing regions in a similar way to the parallax barrier structure of FIG. 2.

A switching half wave plate 85 is provided after the polarisation sensitive lens structure 84. The switching half wave plate 85 and final exit polariser 86 work in co-operation to select whether the first or second surface profile lens is imaging the light from the image forming display. The surface profile lens structures are offset from one another horizontally by nominally half a lens diameter which also corresponds to nominally one pixel pitch on the image forming device.

The switching half wave plate selects whether light which is polarised along the reference direction or light which is polarised perpendicular to the reference direction is transmitted by the exit polariser 86 of the display. By synchronising the interlacing pattern and images on the image forming device with the switching of the half-wave plate, a full resolution dual-view or 2D mode can be achieved by time multiplexing.

Although the embodiment of FIG. 24 is based on surface relief lenses, the invention is not limited to this geometry. The embodiment may be implemented using any pair of polarisation lens structures that can be switched by a switching half-wave plate.

The invention has been described with particular reference to a display which has, as one mode of operation, a dual view or multi-view display mode. However, the invention is not limited to such a display and may be applied to any display having, as one mode of operation, a multiple view directional display mode including, for example, an (auto)stereoscopic 3D display mode.

It is possible to increase the half-angle between images (see FIG. 3) by grouping sub-pixels together. Often however this reduces a viewer's head freedom due to colour defects as described in co-pending UK patent application 0420945.8. UK patent application 0420945.8 describes colour filter patterns that alleviate this problem.

One aspect of UK patent application 0420945.8 provides a multiple view display comprising: a parallax optic comprising a plurality of parallax elements spaced apart at a single first pitch; and a spatial light modulator comprising a plurality of columns of pixels arranged with a second pitch providing viewpoint correction for creating n primary viewing windows for viewing n views, where n is an integer greater than one, with w columns of pixels being viewable through each parallax element in each viewing window, where w is an integer greater than one, the pixels of each column being of a same colour, the columns being of x different colours, where x is an integer greater than two, and being arranged as a sequence of colours comprising repeating groups of a same sub-sequence, characterised in that each group comprises y subgroups of z columns, where y is an integer greater than one and z is an integer greater than or equal to x, each subgroup containing columns of all x colours, the smallest repetition pitch of the sequence being equal to y.z columns.

The modulator may include a striped colour filter arrangement whose stripes are aligned with the columns.

The number x of colours may be equal to three. The three colours may be primary colours. The primary colours may be red, green and blue.

The number z of columns of each subgroup may be equal to x.

The number w of columns viewable in each window may be equal to two. The number y of subgroups in each group may be equal to three. Each sub-sequence may be red, green, blue, green, blue, red, blue, red, green.

The number w of columns viewable in each window may be equal to three. The number y of subgroups in each group may be equal to six. Each sub-sequence may be red, green, blue, red, green, blue, green, blue, red, green, blue, red, blue, red, green, blue, red, green.

A second aspect of UK patent application 0420945.8 provides a multiple view display comprising: a parallax optic comprising a plurality of parallax elements; and a spatial light modulator comprising a plurality of pixels arranged as rows and columns cooperating with the parallax optic to create n primary viewpoint-corrected viewing windows for viewing n views, where n is an integer greater than one, with a respective single column of pixels being viewable through each parallax element in each viewing window, the pixels being arranged as composite colour groups for displaying respective colour image elements, each group comprising z pixels of x different colours disposed adjacent each other in the same column, where x is an integer greater than two and z is an integer greater than or equal to x, the pixels of each colour for each view being disposed so as to be substantially evenly spaced horizontally and substantially evenly spaced vertically, characterised in that the order in the column direction of the colours of the pixels of each group is different from the order in the column direction of the colours of the pixels of each adjacent group in the same rows.

The pixels of each colour may be disposed so as to be substantially evenly spaced horizontally and substantially evenly spaced vertically on the modulator.

The pixels may be arranged in the row direction as repeating sets of z pixels of the x different colours with each row being offset in the row direction relative to each adjacent row by a number of pixels greater than zero and less than z. The offsets between adjacent rows may have the same magnitudes. The offsets between adjacent rows may have the same directions.

The number x of different colours may be three. The three colours may be primary colours. The primary colours may be red, green and blue.

The number z of pixels in each group may be equal to x.

A third aspect of UK patent application 0420945.8 provides a multiple view display comprising: a parallax optic comprising a plurality of parallax elements; and a spatial light modulator comprising a plurality of pixels arranged as rows and columns cooperating with the parallax optic to create n primary viewpoint-corrected viewing windows for viewing n views, where n is an integer greater than one, with w pixels in each row being viewable through each parallax element in each viewing window, where w is an integer greater than one, characterised in that the rows are arranged as groups and the parallax elements are arranged as rows, each of which is aligned with a respective group of rows of pixels, the pixels comprising sets of pixels of different colours arranged such that the sequence of pixel colours viewable in each viewing window through each parallax element of each row of parallax elements is different from the sequence of pixel colours viewable through the or each nearest parallax element in the or each adjacent row of parallax elements.

The parallax elements may be aligned in the row direction. The parallax elements may be continuous in the column direction. The pixels may be arranged as repeating colour sequences in the row direction and the rows of pixels of each adjacent pair of groups may be offset with respect to each other in the row direction by at least one pixel pitch and by less than the smallest repetition pitch of the repeating colour sequence.

The pixels of each colour may be arranged as columns. The parallax elements of each adjacent pair of rows may be offset with respect to each other in the row direction.

The offsets may be of the same magnitude.

The offsets may be in the same direction.

The groups of rows of pixels or the rows of parallax elements may be arranged as sets with offsets of the sets being in the same direction and with the offsets of adjacent pairs of sets being in opposite directions.

Each group of rows may comprise a single row.

Each group of rows may comprise a plurality of rows. Each group of rows may comprise n rows, the display may be rotatable between a portrait orientation and a landscape orientation, and the parallax elements may be arranged to provide two dimensional parallax. The offset may differ from twice the pitch of the columns to provide viewpoint correction. The pixels of each row may be arranged as groups of n.w pixels separated from each other by the pitch of the columns.

The number w may be equal to two and the different sequences of pixel colours may comprise different combinations.

The number w may be equal to three and the different sequences of pixel colours may comprise different permutations.

The parallax optic may be a parallax barrier.

The spatial light modulator may be a light-attenuating modulator. The modulator may be transmissive. The modulator may be a liquid crystal device.

The number n of windows may be equal to two.

The sets of pixels may be of three colours. The three colours may be primary colours. The primary colours may be red, green and blue.

A colour filter pattern according to any aspect of UK patent application 0420945.8 may be applied to any of the embodiments described in the present application.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

1. A display having a first multiple view mode of operation and a second single view mode of operation, comprising: a transmissive spatial light modulator arranged, in the first mode, to display a plurality of spatially multiplexed images for viewing in respective different viewing regions and, in the second mode, to display a single image for viewing in a single relatively large viewing region, the modulator having an input polariser arranged to pass light of a first polarisation; and a backlight having a light output surface comprising first regions spaced apart by second regions and being electronically switchable between the first mode, in which only the first regions emit light containing the first polarisation, and the second mode, in which both the first and second regions emit light containing the first polarisation.

2. A display as claimed in claim 1, in which the output surface comprises a patterned retarder and the first and second regions are arranged to provide a difference in retardation of λ/2, where λ is a wavelength of visible light.

3. A display as claimed in claim 2, in which the backlight comprises a light guide disposed behind the output surface, a first light source arranged to supply polarised light into the light guide, and a second light source arranged to supply unpolarised light into the light guide.

4. A display as claimed in claim 1, in which the first polarisation is a linear polarisation and the backlight comprises a light guide and first and second light sources arranged to supply into the light guide light of second and third linear polarisations which are orthogonal and which are oriented at + and −45°, respectively, to the first polarisation.

5. A display as claimed in claim 4, in which the first regions are index-matched to the light guide for only the second polarisation and the second regions are index-matched to the light guide for only the third polarisation.

6. A display as claimed in claim 1, in which the output surface comprises a liquid crystal device and the second regions are switchable between a light-blocking mode and a light-transmitting mode for the first and second modes of operation, respectively.

7. A multiple view display comprising: a spatial light modulator comprising a plurality of pixels and being arranged to display N spatially multiplexed images simultaneously in each time frame of a cyclically repeating set of N time frames, where N is an integer greater than one, such that each pixel displays an image pixel of different ones of the images in different time frames of each set; and a parallax optic cooperating with the modulator to make each of the N images visible in the same respective one of the N viewing regions during all of the time frames.

8. A display as claimed in claim 7, in which the parallax optic comprises parallax elements whose positions are different in the N frames of each set.

9. A display as claimed in claim 8, in which the parallax optic comprises a parallax barrier.

10. A display as claimed in claim 7, in which N is equal to two.

11. A display as claimed in claim 9, in which N is equal to two and the barrier comprises a switching half wave plate and a patterned retarder.

12. A display as claimed in claim 11, in which the patterned retarder is a patterned half wave plate.

13. A display as claimed in claim 12, in which the patterned half wave plate comprises first and second regions having optic axes oriented at + and −22.5°, respectively, with respect to a reference direction and the switching half wave plate has an output polarisation which is switchable between + and −45°, the barrier comprising a polariser having a transmission axis at 45°, the switching half wave plate and the patterned half wave plate being disposed between the polariser and a further polariser having a transmission axis at 90°.

14. A display as claimed in claim 1, in which the modulator is a liquid crystal device.

15. A display having a first multiple view mode of operation and a second single view mode of operation, comprising: a transmissive spatial light modulator comprising a plurality of pixels and a backlight; the modulator being arranged, in the first mode, to display N spatially multiplexed images simultaneously in each time frame of a cyclically repeating set of N time frames, where N is an integer greater than one, such that each pixel displays an image pixel of different ones of the images in different time frames of each set, and being arranged to display, in the second mode, a single image for viewing in a single relatively large viewing region, and the backlight being switchable between the first mode, in which it cooperates with the modulator to make each of the N images visible in the respective one of the N viewing regions during all of the time frames, and the second mode.

16. A display as claimed in claim 15, in which the modulator is arranged, in the second mode, to display the single image by all of the modulator pixels.

17. A display as claimed in claim 15, in which the backlight comprises a plurality of parallel light output strips.

18. A display as claimed in claim 17, in which adjacent ones of the strips are contiguous with each other.

19. A display as claimed in claim 17, in which the strips are arranged as groups of M strips below each column of pixels, where M is an integer greater than one.

20. A display as claimed in claim 19, in which M is equal to (N+1), all of the strips emit light in the second mode and, in the first mode, each of N of the strips of each group emits light during a respective one of the N time frames of each set.

21. A display as claimed in claim 17, in which the pitch of the strips is substantially equal to an integer multiple of a column pitch of the pixels.

22. A display as claimed in claim 17, in which the output strips are light-emitting strips.

23. A display as claimed in claim 15, wherein the modulator has an input polariser arranged to pass light of a first polarisation; and the backlight has a light output surface comprising first regions spaced apart by N second regions and being electronically switchable between the first mode, in which only the i^{th} second region emits light containing the first polarisation in each i^{th} time frame of each repeating cycle of N time frames, and the second mode, in which both the first and second regions emit light containing the first polarisation.

24. A multiple view display comprising: a transmissive spatial light modulator having at least a first region for modulating light of a first wavelength range and a second region for modulating light of a second wavelength range not overlapping the first wavelength range; and a backlight having at least a first region for outputting light within the first wavelength range and a second region for outputting light within the second wavelength range; wherein the spatial light modulator and the backlight are arranged such that light output from the first region of the backlight along a predetermined axis of the display is not incident on the first region of the spatial light modulator and such that light output from the second region of the backlight along a predetermined axis of the display is not incident on the second region of the spatial light modulator.

25. A multiple view display comprising:
a transmissive spatial light modulator comprising repeating groups of X columns of pixels, where X is an integer greater than one and each ith column of each group is arranged to modulate light in an ith wavelength range and substantially to block light in each jth wavelength range for all i and j such that 1≦i≦X, 1≦j≦X and i≠j; and
a backlight having repeating groups of X light output strips extending parallel to the pixel columns, where each ith strip is arranged to output light in the ith wavelength range and outside each jth wavelength range, the width of each ith strip being less than or equal to the width of the space between adjacent ith columns of adjacent column groups.

26. A display as claimed in claim 25, in which X=3.

27. A display as claimed in claim 26, in which the wavelength ranges comprise red, green and blue wavelength ranges.

28. A display as claimed in claim 25, in which adjacent pairs of the strips are substantially contiguous with each other.

29. A display as claimed in claim 25, in which the backlight comprises a carbon nanotube backlight.

30. A display as claimed in claim 25, in which the ith columns of each adjacent pair are laterally symmetrically disposed with respect to a corresponding ith strip.

31. A display as claimed in claim 25, in which each column comprises a single line of pixels.

32. A backlight having at least a first region for outputting light within a first wavelength range and a second region for outputting light within a second wavelength range not overlapping with the first wavelength range, the first region comprising an emissive material emitting, in use, light within the first wavelength range and the second region comprising an emissive material emitting, in use, light within the second wavelength range.

33. A backlight as claimed in claim 32, comprising a carbon nanotube backlight.

34. A backlight as claimed in claim 32, in which the at least first and second regions comprise a plurality of regions arranged as repeating groups.

35. A display as claimed in claim 15, in which the backlight comprises a light guide, a visible light source arranged to emit visible light into the light guide, and an ultraviolet light source arranged to emit ultraviolet light into the light guide, the light guide having first output regions which are transparent to visible light interlaced with second output regions comprising ultraviolet-activated luminescent material.

36. A display as claimed in claim 7, in which the parallax optic comprises first and second polarisation sensitive lens arrays offset laterally with respect to each other and sensitive to orthogonal linear polarisations, a switching half wave plate, and an output linear polariser.

37. A display as claimed in claim 7, in which the modulator is a liquid crystal device.
